(19) United States
(12) Patent Application Publication
(10) Pub. No.: US 2019/0263266 A1
(43) Pub. Date: Aug. 29, 2019

(54) ELECTRICITY COLLECTOR DEVICE

(71) Applicant: Yannick Algret, Shrewsbury (GB)

(72) Inventor: Yannick Algret, Shrewsbury (GB)

(21) Appl. No.: 16/349,121

(22) PCT Filed: Nov. 10, 2017
(86) PCT No.: PCT/GB2017/053400

§ 371 Date: May 10, 2019

(30) Foreign Application Priority Data
Nov. 10, 2016 (GB) 1619024.1

(51) Int. Cl. B60L 5/36; B60L 5/40; B60L 5/38; B60M 1/34; B60M 1/12; B60L 5/20; B60L 5/04

(52) U.S. Cl. CPC B60L 5/36; B60L 5/40; B60L 5/38; B60K 6/20; B60M 1/12; B60L 5/20; B60L 5/04; B60M 1/34

(57) ABSTRACT

An electricity collector device (100) for connecting a vehicle (200) to electrical supply rails (308, 309) in a conduit (304) is disclosed. The device (100) comprises a collector system (400), a wheeled enclosure (101), a vehicle connection (150) and a power cable (104). The collector system (400) comprises a retractable collector arm (401, 402) adapted to be inserted into a conduit (304) containing an electrical supply rail (309, 309), and to make electrical contact with the supply rail (308, 309). The wheeled enclosure (101) houses the collector system (400), and comprises flanged wheels (102, 103) adapted to be engageable with the conduit (304). The vehicle connection (150) is for attaching the device to a vehicle (200), allowing the enclosure (101) to move with least two degrees of freedom with respect to the vehicle (200). The power cable (104) is for connecting the collector system (400) to a vehicle (200).

### FIELD OF THE INVENTION

The invention relates to an electricity collector device, particularly to an electricity collector device suitable to be attached to an electric vehicle to supply electricity to the vehicle from an electrical supply rail.

### BACKGROUND

Electric vehicles such as electric cars and electric lorries are increasingly common on today's roads. Electric vehicles reduce or eliminate the harmful emissions associated with internal combustion engines, such as carbon dioxide and nitrogen oxides, without presenting the engineering complexities of hydrogen fuel cell vehicles.

In a typical electric vehicle, electricity is supplied from an on-board battery. The battery must be charged before the start of a journey, and the vehicle's range is limited by how long the battery can supply electricity for. Charging times for batteries can be very long, particularly for the larger batteries used to provide extended range. These impracticalities make electric vehicles undesirable to many people. Batteries can also have high cost relative to the rest of the vehicle, and have limited lifespans. There are also major concerns around disposal or recycling of batteries, their ecological impact, and the depletion of natural resources caused by their production. Furthermore batteries required for vehicles rapidly become unfeasible (due to their cost, size and weight) as the power requirement for them increases, for example, heavy goods vehicles require much more power than a small car.

Rapid charging stations for electric vehicles have started to appear. These charging stations can reduce the time needed to charge a battery from ˜8 hours to around 30 minutes. However, a stop of 30 minutes is still much longer than it takes to refuel a petrol or diesel vehicle, limiting the appeal of electric vehicles.

Storing and retrieving energy from electrochemical cells, or any other energy storage means has associated inefficiencies, resulting in energy losses. Weight of the batteries is another additional limitation in terms of designing more energy efficient electric or hybrid electric vehicles.

There is therefore a need to provide an alternative solution for powering of electric vehicles or for charging the batteries of electric vehicles.

It has long been known to power electric trams or trains from overhead cables or from third rails. These solutions provide a constant supply of electricity to the tram or train throughout a journey. However, these solutions have not been applied to private vehicles such as cars and lorries using public roads. For safety reasons, third rails are generally only used on railways where people are not expected to come into contact with the third rail. Overhead cables must be placed high enough for large vehicles to pass under them—requiring an impractically long pole to connect a car to the high overhead cables.

Moreover, both third rails and overhead cables require vehicles to be substantially modified to contain a system for connecting the vehicle to the power source, such as a pantograph for overhead cables. It is difficult to fit such a system into a normal car, without a substantial loss of space available for the passengers. In practice, such a system tends to require the car to be initially designed with an electricity connection system, rather than being able to retrofit a connection system onto a vehicle.

### SUMMARY OF THE INVENTION

In accordance with the invention there is provided an electricity collector device for connecting a vehicle to electrical supply rails in a conduit, the device comprising: a collector system comprising a retractable collector arm adapted to be inserted into a conduit containing an electrical supply rail, and to make electrical contact with the supply rail; a wheeled enclosure housing the collector system, the wheeled enclosure comprising flanged wheels adapted to be engageable with the conduit; a vehicle connection for attaching the device to a vehicle, the vehicle connection allowing the enclosure to move with least two degrees of freedom with respect to the vehicle; and a power cable for connecting the collector system to a vehicle.

Such a device may be used to connect an electric vehicle to an external electricity source in a conduit on the road, eliminating the need to charge a battery in advance of a journey. Advantageously, the device may be retrofitted to an existing vehicle, for example by trailing the device behind or under the vehicle. Retrofitting the device to existing vehicles minimises the costs of implementing the supply rail system.

In some embodiments, the collector arm may comprise a collector rod for contacting a supply rail, and an insertion rod attached to the collector arm, wherein the collector rod and/or the insertion rod is adapted to be rotated to contact a supply rail.

Such a collector arm may be inserted into a conduit, and manoeuvred to contact the supply rail, allowing the supply rail to be located in a position which minimises the risk of external objects contacting the rail.

In some examples the collector rod may be rotatably attached to the insertion rod. The collector arm may for example be adapted to be inserted into a conduit in an insertion direction, and the collector rod may be rotatable about a first rotation direction, the rotation direction being substantially parallel to the insertion direction.

Alternatively the collector arm is adapted to be inserted into a conduit in an insertion direction, and the collector rod may be rotatable about a first rotation direction, the rotation direction being substantially orthogonal to the insertion direction. In such examples the collector arm may further comprise a support beam, the support beam connecting the collector rod to the insertion rod, wherein the collector rod is rotatably connected to the support beam, and the support beam is rotatably connected to the insertion rod. Such a three part collector arm may allow greater manoeuvrability of the collector arm within the conduit.

In some such examples, the support beam may be rotatable with respect to the insertion rod about a second rotation direction, the second rotation direction being substantially orthogonal to the insertion direction, and the collector rod may be rotatable with respect to the support beam about the first rotation direction. For example, the second rotation direction may be substantially orthogonal to the first rotation direction.

In some embodiments, the collector arm may be operable to be translated in a direction opposite to the insertion direction when the insertion rod is rotated away from the insertion direction.

In some embodiments, the collector rod may be operable to be rotated by an angle of at least 90 degrees from the rotation direction, or by an angle of at least 120 degrees from the rotation direction.

In some embodiments, the vehicle connection may comprise a slider rail attachable to a vehicle, the slider rail allowing the wheeled enclosure to move laterally with respect to the vehicle.

In some embodiments, the vehicle connection may allow the enclosure to move with respect to an attached vehicle with five or six degrees of freedom. By allowing such a high degree of relative motion between the enclosure and the vehicle, small movements of the vehicle can be corrected for, so that connection to the supply rail is not interrupted.

In some embodiments, the vehicle connection may comprise a plurality of rotational joints, each joint providing a degree of freedom to the movement of the enclosure with respect to an attached vehicle.

Some embodiments may further comprise a sensor system operable to determine the position of a conduit containing a supply rail, and to direct the collector arm into the conduit. For example, the sensor system may be used to detect a conduit on a road surface, and to automatically deploy the enclosure and/or collector arm to establish an electrical connection with a supply rail in the conduit. The sensor system may for example comprise an optical sensor, an electromagnetic sensor, or an acoustic sensor. The sensor system, or sensors of the sensor system, may be carried on the slider rail. In embodiments with a collector arm, the collector system may comprise at least one actuator operable to translate the collector arm and/or rotate the collector rod.

In some embodiments, the collector system may comprise a second retractable collector arm adapted to be inserted into a second conduit containing a second supply-rail, and to make contact with the second supply rail. For example, one conduit may contain a live rail, and one conduit may contain a neutral rail. The device may have to form an electrical connection to both rails to collect electricity.

According to a second aspect of the invention there is provided an electric vehicle system comprising an electric vehicle attached to an electricity collector device according to any embodiment of the first aspect.

According to a third aspect of the invention there is provided a sub-surface electrical supply system for providing electricity to an electricity collector device of a vehicle, the system comprising: support walls defining an elongate electrical conduit, the support walls comprising a top wall, a bottom wall, and opposing first and second side walls; an elongate slit in the top wall for receiving a collector arm of an electricity collector device insertable into the conduit, said slit being further adapted to support flanged wheels of a wheeled device; and an electricity supply rail located in the conduit for supplying electricity to a collector arm of an electricity collector device inserted into the conduit.

The slit may be located adjacent to the first side wall, and the supply rail may be attached to the second side wall.

In some embodiments, the system may further comprise at least one insulating bar between the supply rail and the slit, the insulating bar extending from or attached to the top or bottom wall, the insulating bar adapted to limit access to the supply rail from the slit. The supply system may additionally or alternatively comprise a plurality of insulating fins extending from the bottom wall.

The insulating bar and/or fins may limit the number of possible pathways between the slit and the supply rail, minimising the chance of an external object falling into the slit and making contact with the supply rail. The fins may additionally prevent thin, flexible external objects from curling within the conduit towards the supply rail.

In some embodiments, the supply system may further comprise a drainage port for draining the cavity.

In some embodiments, the supply system may be adapted to be placed under a road surface such that the top wall is substantially level with the road surface. Alternatively the supply system may be placed on top of a road system, providing a less costly option for installation of the supply system than under the road surface.

Some embodiments may further comprise second support walls defining a second elongate conduit, and a second electricity supply rail located in the second conduit. For example, the first conduit may contain a live supply rail, and the second conduit may contain a neutral supply rail.

In some embodiments the supply system may further comprise a guard covering the elongate slit, wherein the guard is operable to allow a collector arm of an electricity collector device to be inserted through the guard and into the slit. The guard may prevent foreign objects falling through the slit and contacting the supply rail, whilst still allowing the collector arm to access the conduit.

The guard may comprise a first cover and a second cover extending across opposite sides of the slit, the first and second cover meeting to form a seal which is penetrable by a collector arm. The first cover may be a first arched cover, and the second cover may be a second arched cover. The first cover and second cover may comprise rails, for example steel rails, along the edges where the first and second cover meet. The rails may be configured to cooperate with rollers on a collector arm, so that a collector arm may move along the conduit, separating the first and second covers ahead of it, with minimal friction.

According to a fourth aspect of the invention there is provided a method of supplying electricity to an electric vehicle, the method comprising: attaching an electricity collector device to the vehicle, the collector device comprising a collector system housed in a wheeled enclosure, the wheeled enclosure able to move with at least two degrees of freedom with respect to the vehicle; inserting a collector arm of the collector system into a conduit containing an electricity supply rail; and maneuvering the collector arm inside the conduit until the collector arm contacts the supply rail.

In some embodiments, the collector arm may comprise a collector rod for contacting a supply rail, and an insertion rod rotatably connected to the collector arm. The step of maneuvering the collector arm inside the conduit may comprise rotating the collector rod about the insertion rod, so that the collector rod contacts the supply rail.

In some embodiments, the collector arm may further comprise a support beam, the support beam connecting the collector rod to the insertion rod, wherein the collector rod is rotatably connector to the support beam, and the support beam is rotatably connected to the insertion rod. Manoeuvring the collector arm inside the conduit comprises may comprise: rotating the support beam about the insertion rod; and rotating the connector rod about the support beam, so that the collector rod contacts the supply rail.

In some embodiments, maneuvering the collector arm inside the conduit may comprise: rotating the collector rod about the insertion rod, so that the collector rod contacts the supply rail; and partially extracting the collector arm from the conduit with the collector rod rotated, so that the collector rod contacts the supply rail.

In some embodiments, the method may further comprise the step of detecting the conduit with a sensor system of the collector device.

In some embodiments, the method may further comprise the steps of: detecting that the vehicle has moved a pre-determined distance away from the conduit; and retracting the collector arm from the conduit.

According to a fifth aspect of the invention there is provided electricity collector device for connecting a vehicle to electrical supply rails in a conduit, the device comprising: a collector system comprising a retractable collector arm adapted to be inserted into a conduit containing an electrical supply rail, and to make electrical contact with the supply rail; a wheeled enclosure housing the collector system; a vehicle connection for attaching the device to a vehicle; and a power cable for connecting the collector system to a vehicle; wherein the collector system is configured to move with at least one degree of freedom within the enclosure. The vehicle connection may allow the enclosure to move relative to the vehicle.

A collector device according to the fifth aspect may have the same advantages as the collector device according to the first aspect. In particular the collector device is configured to move within the enclosure in order to maintain a position over a conduit that enables the collection device to make contact with the electrical supply rail.

In some embodiments the collector system may be configured to move laterally within the enclosure. For example the enclosure may comprise a slider rail, and the collector device may be configured to slide laterally along the slider rail within the enclosure. The width of the enclosure may be substantially the width of the vehicle, so that there is space within the enclosure for the collector device to move.

In some embodiments the collector system may be configured to rotate within the enclosure, or to move to adjust the pitch, roll, and/or yaw of the collector device within the enclosure. These movements may further enable the collector device to maintain contact with a supply rail whilst the vehicle is moving.

In some embodiments the collector device may be configured to extend laterally from the enclosure. For example conduit may be located to the side of the enclosure, and the collector device may be extended from a side of the enclosure in order to make contact with a supply rail in the conduit. The collector device may comprise a telescopic extension arm operable to extend the collector device laterally from the enclosure. The collector device may be free to move laterally when extended from the enclosure in order to maintain connection with the supply rail as the vehicle moves.

Any embodiment of the collector device of the first aspect may be combined with the collector device of the fifth aspect.

### DETAILED DESCRIPTION

The invention is described in further detail below by way of example and with reference to the accompanying drawings, in which:

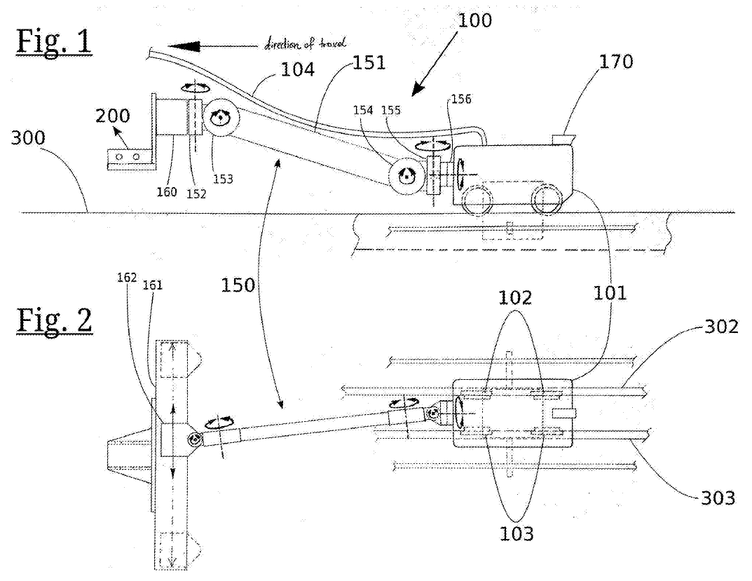

FIG. 1 is a schematic representation of a collector device;

FIG. 2 is an alternative view of the device in FIG. 1;

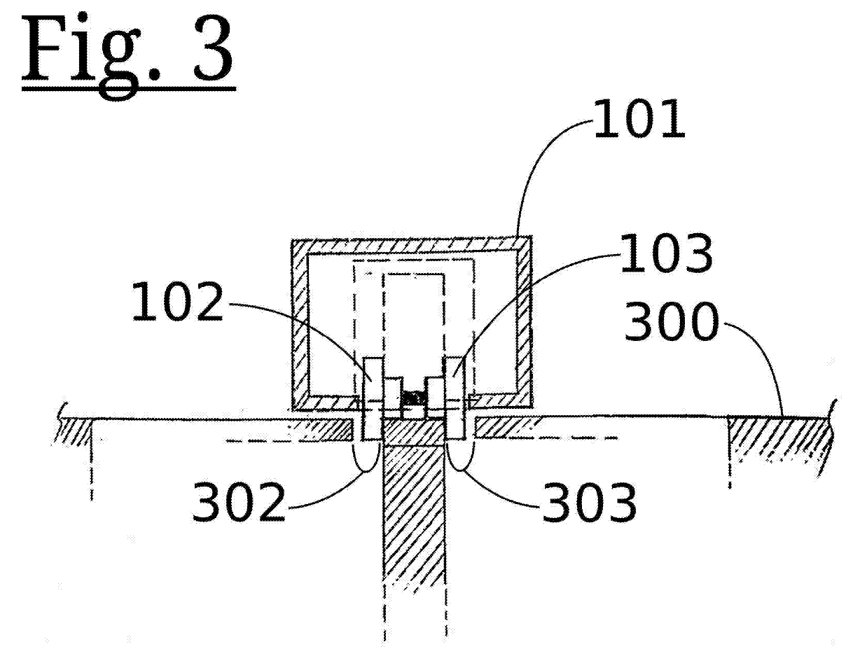

FIG. 3 is an alternative view of the device in FIG. 1;

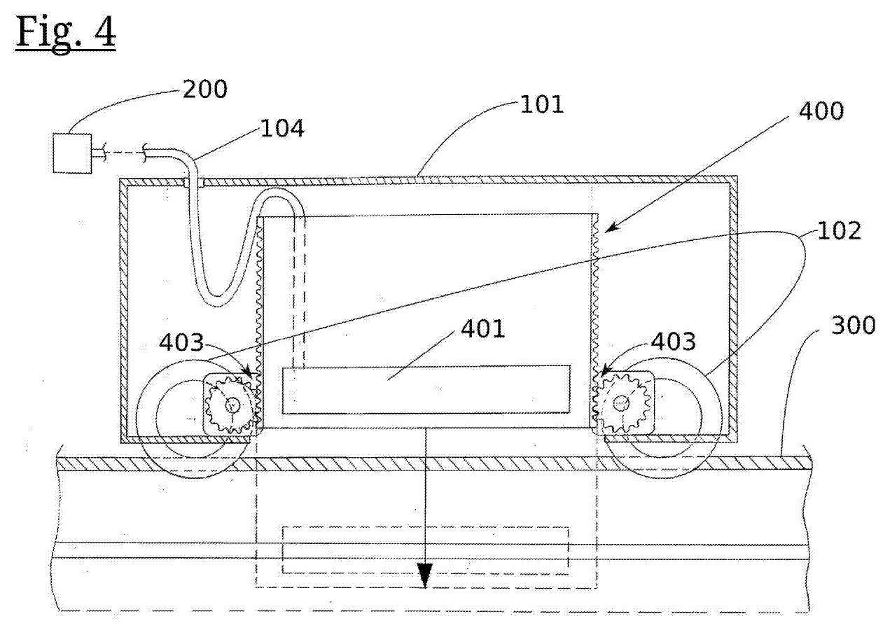

FIG. 4 is a schematic representation of the mechanism inside the enclosure of the device of FIG. 1;

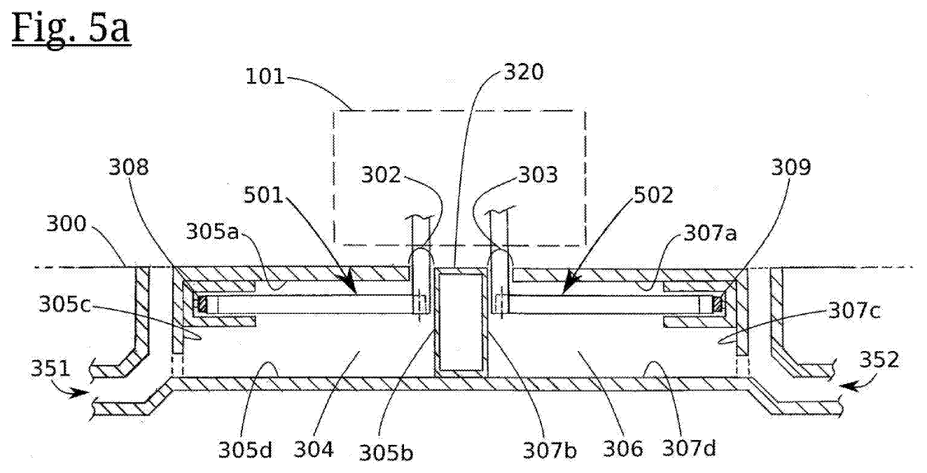

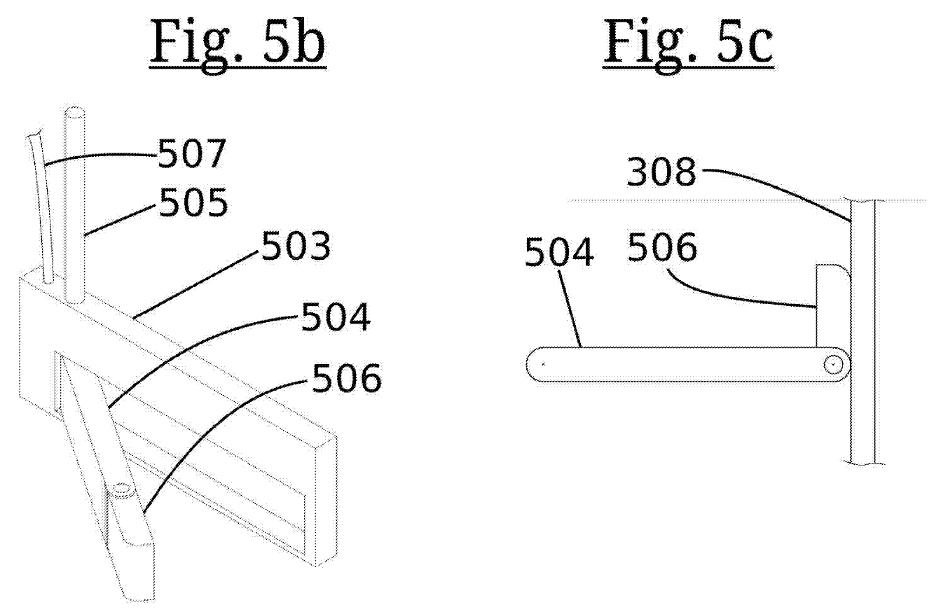

FIGS. 5a-c show representations of one example of a collector arm;

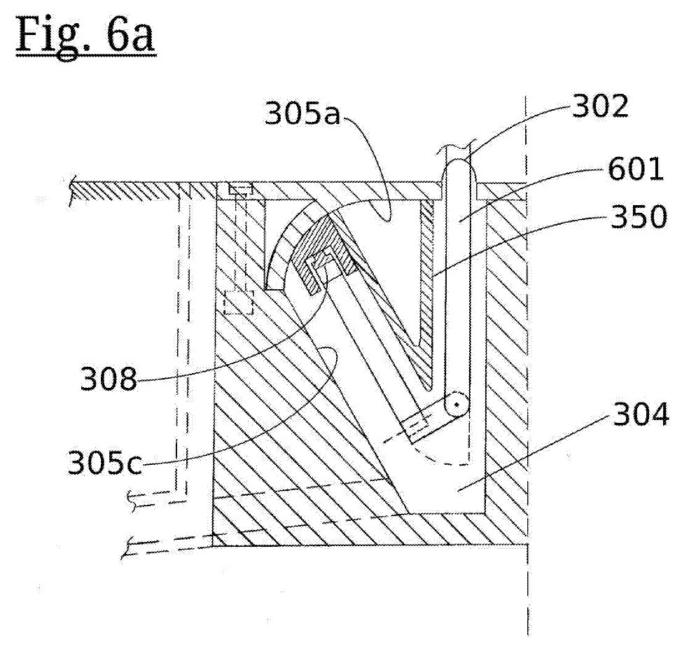

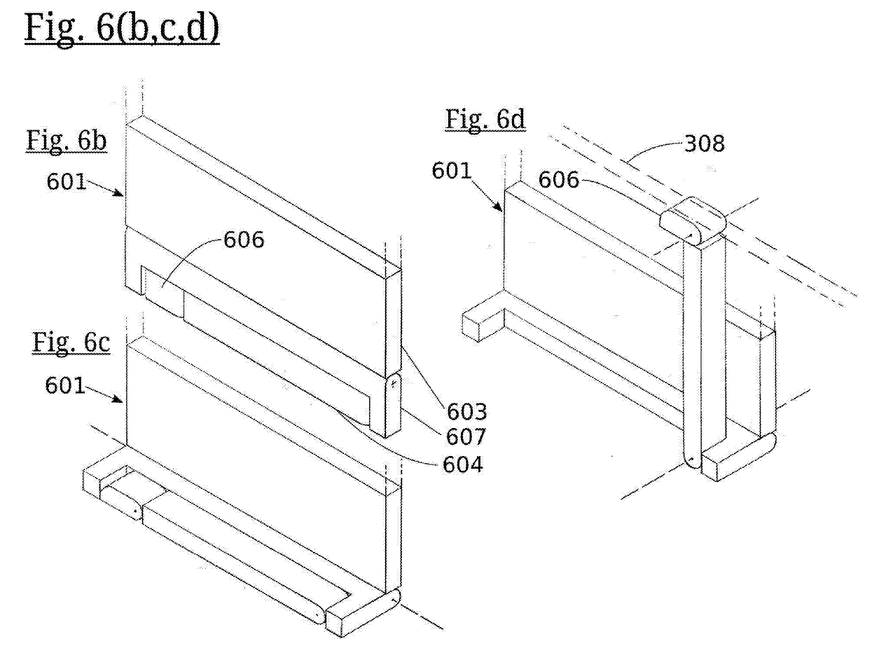

FIGS. 6a-d show representations of an alternative example of a collector arm;

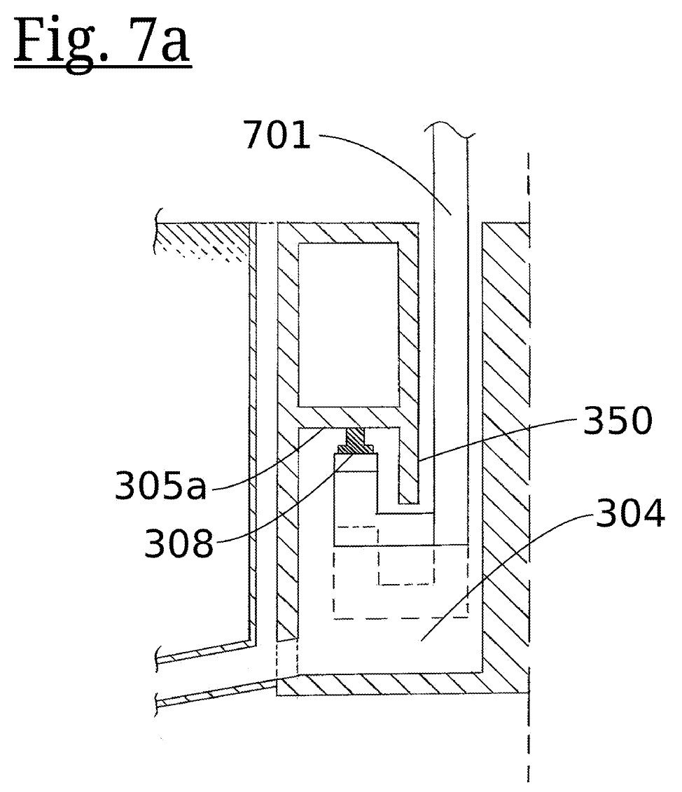

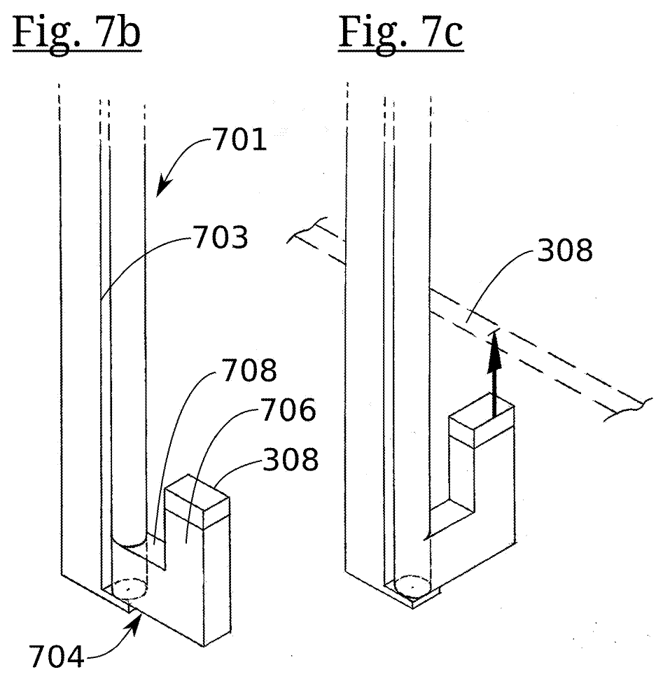

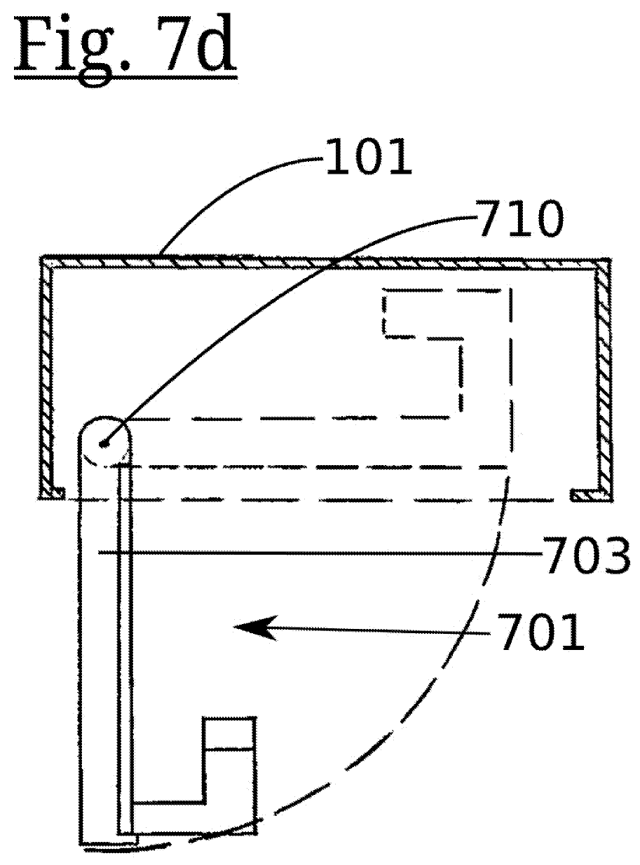

FIGS. 7a-d show representations of an alternative example of a collector arm;

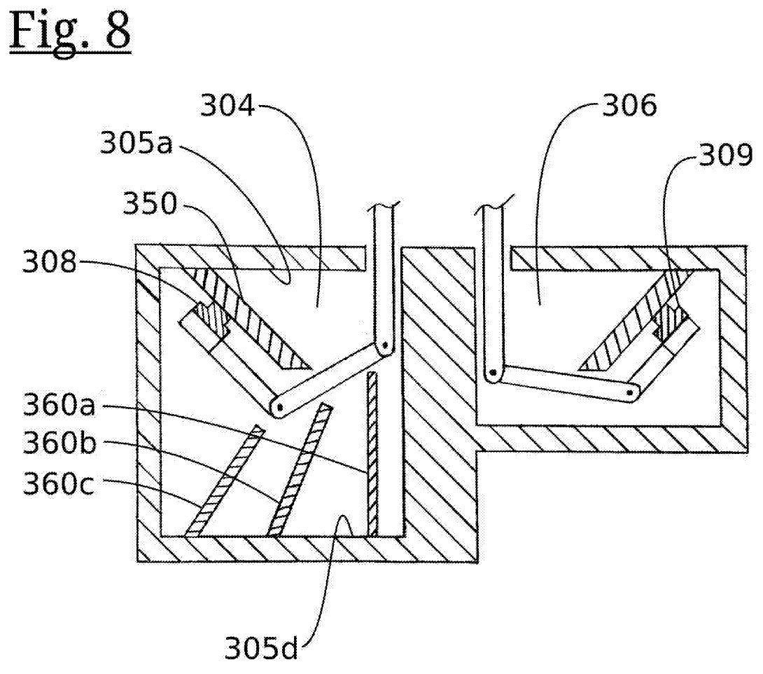

FIG. 8 is a representation of an alternative supply system;

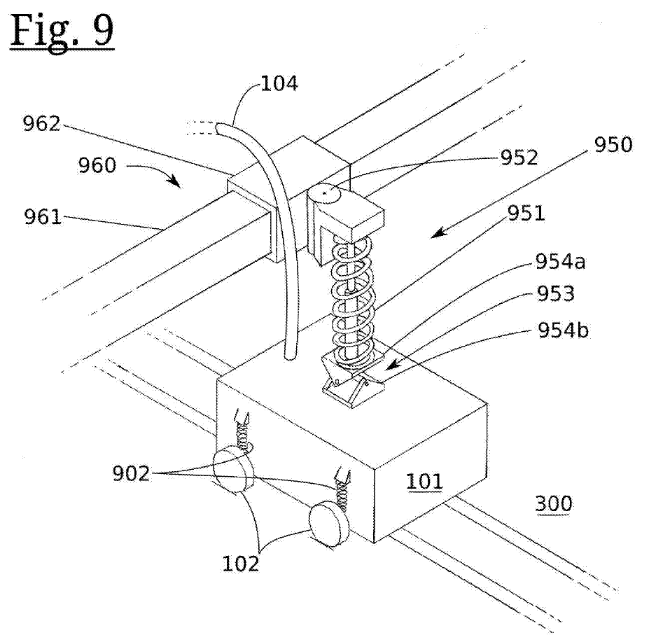

FIG. 9 is a representation of an alternative vehicle connector;

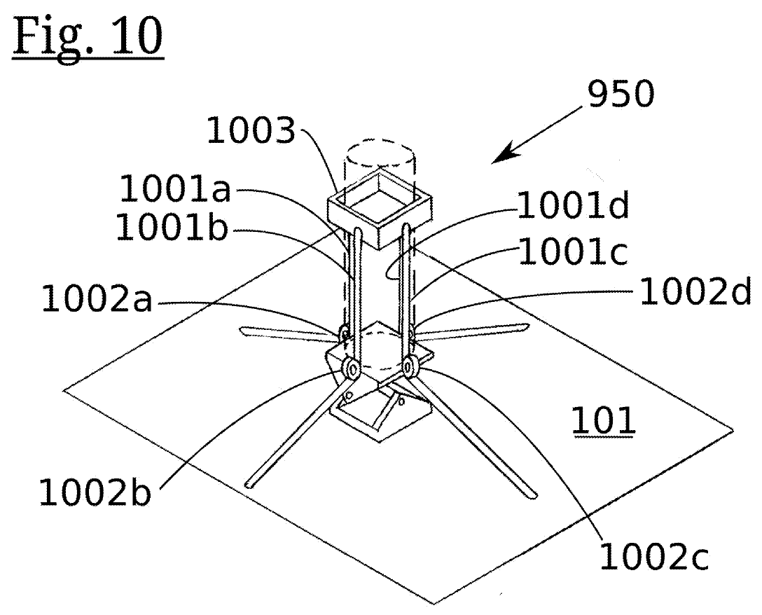

FIG. 10 is a representation of an alternative vehicle connector;

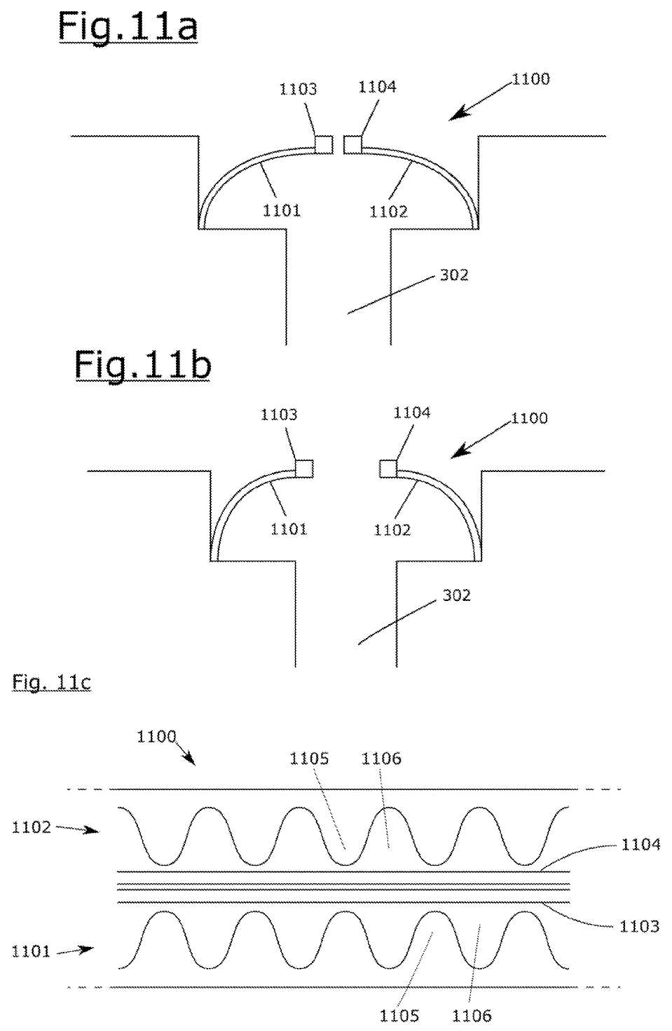

FIGS. 11a-c show representations of a supply system comprising a guard;

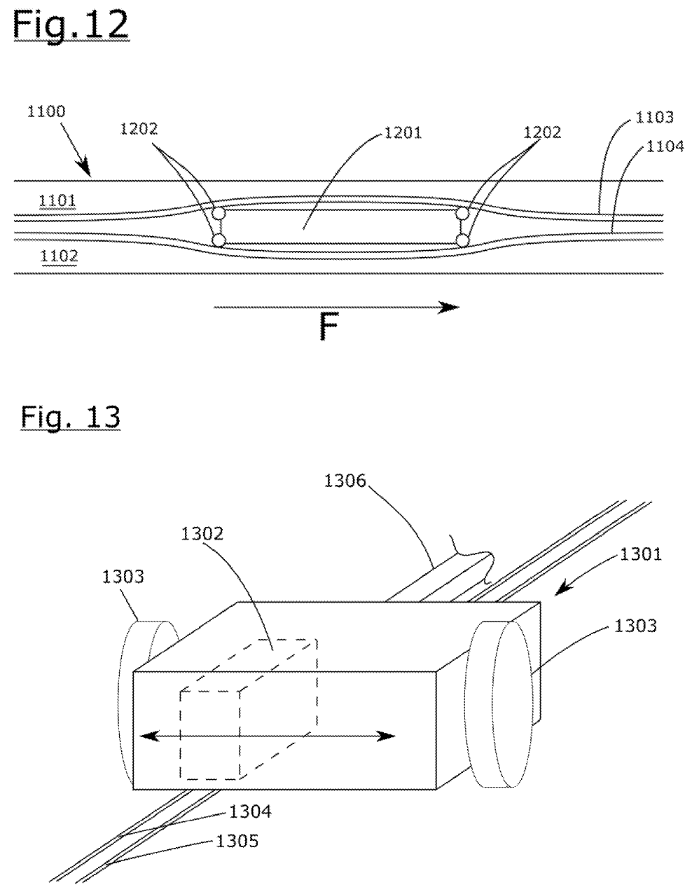

FIG. 12 shows an alternative representation of the system of FIGS. 11a-c;

FIG. 13 shows a representation of an alternative collector device; and

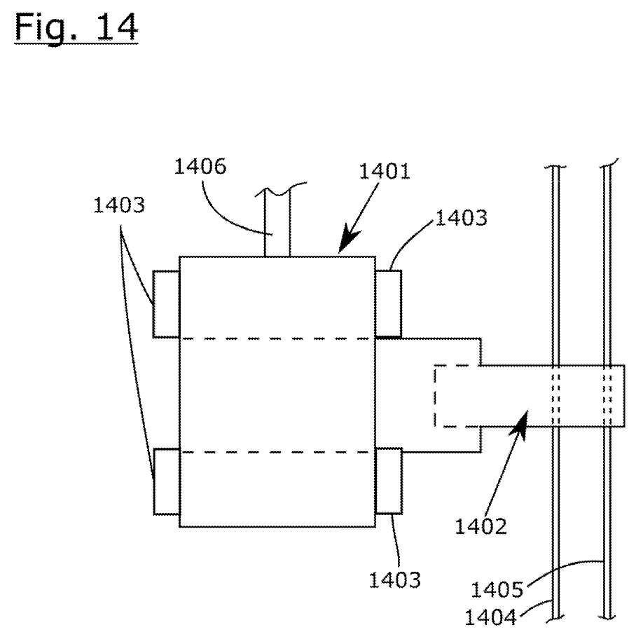

FIG. 14 shows a representation of a further alternative collector device

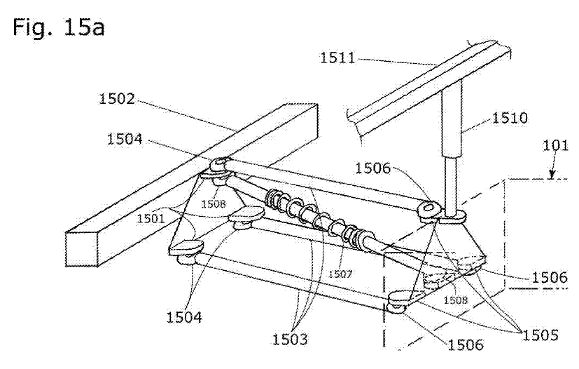

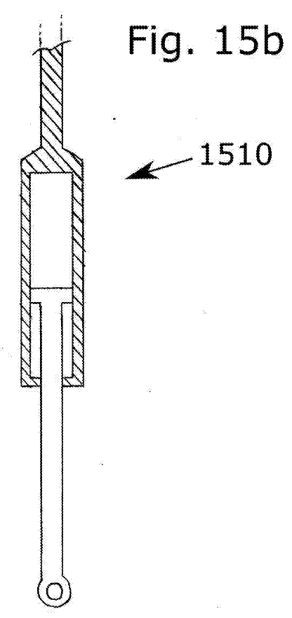

FIGS. 15a and b show a representation of an alternative vehicle connection;

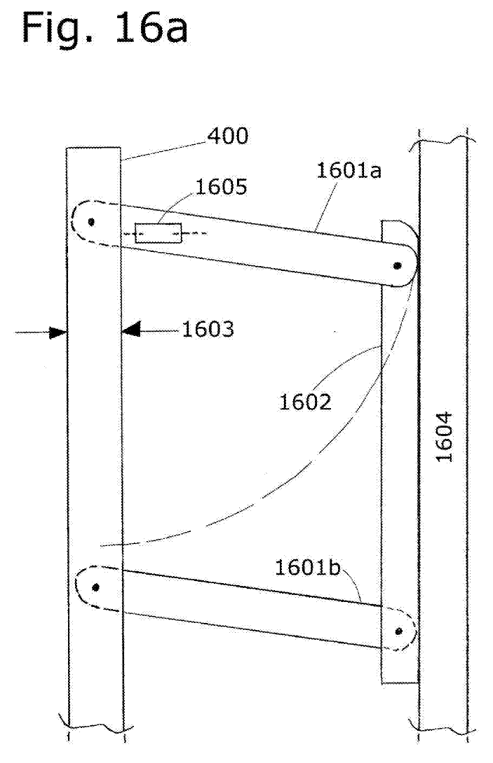

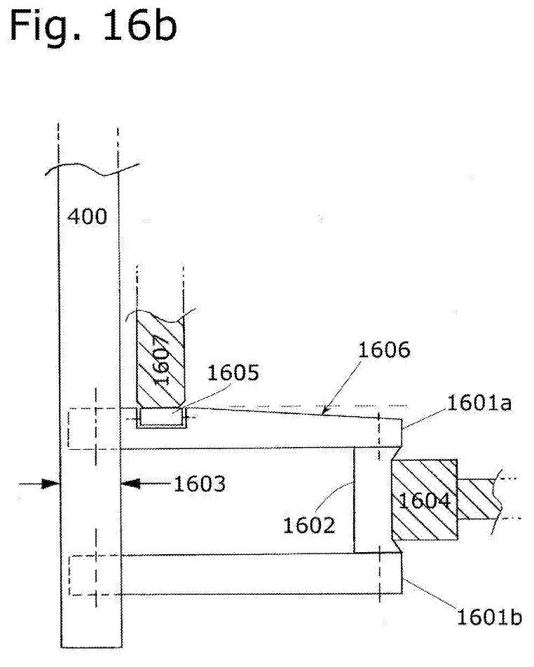

FIGS. 16a and b shows a representation of a mechanism for actuating moving brushes;

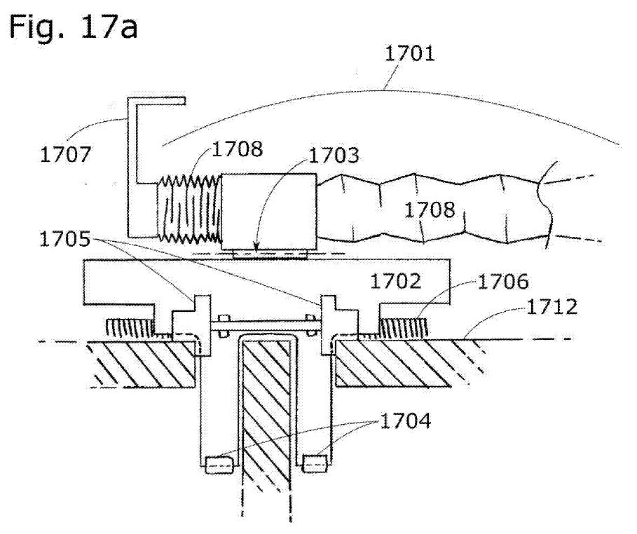

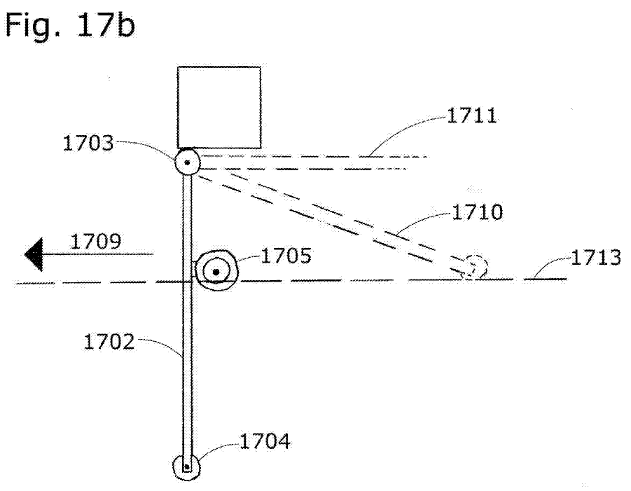

FIGS. 17a and b show a representation of a device to detect foreign objects in the conduit;

FIG. 8 shows a representation of an alternative actuation system;

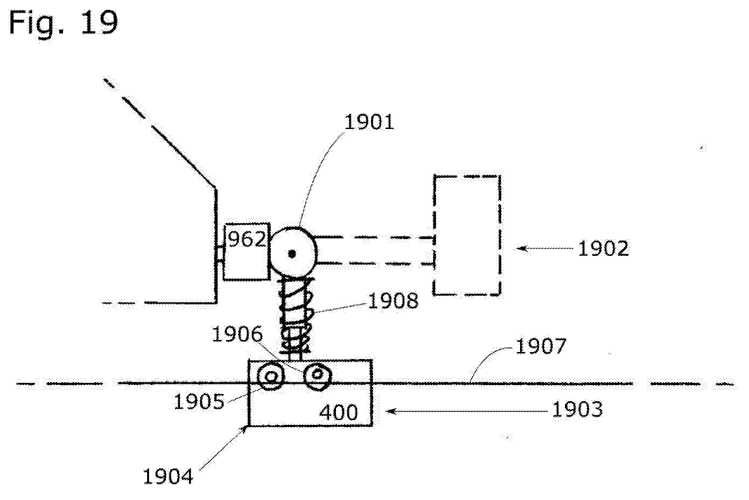

FIG. 19 shows a representation of a further alternative vehicle connection;

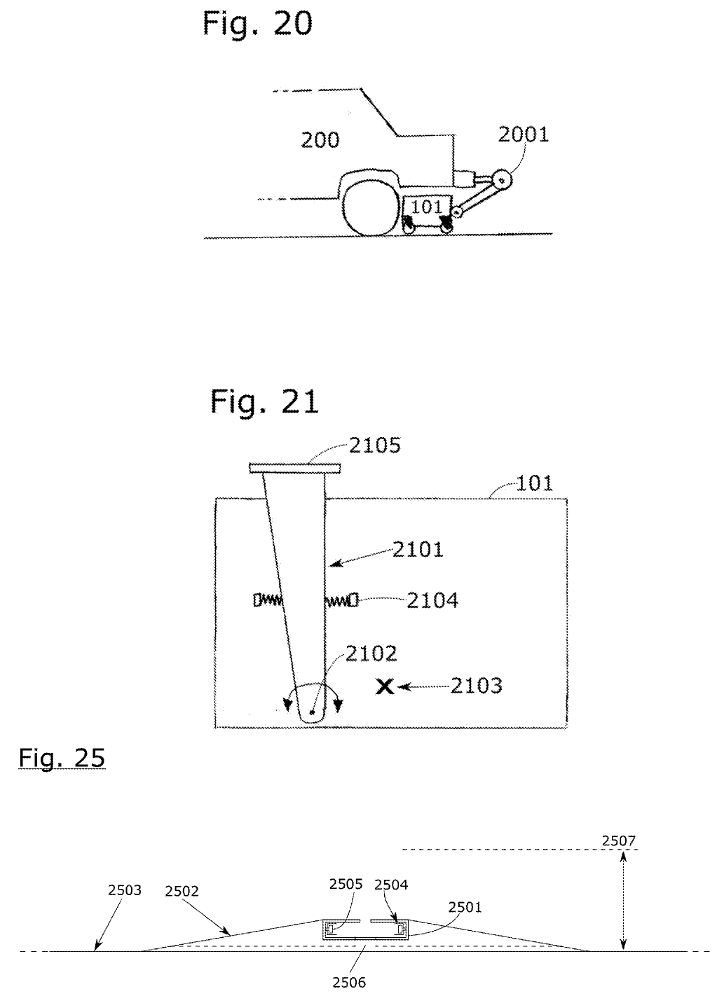

FIG. 20 shows a representation of a further alternative vehicle connection;

FIG. 21 shows a representation of a vehicle connection bracket;

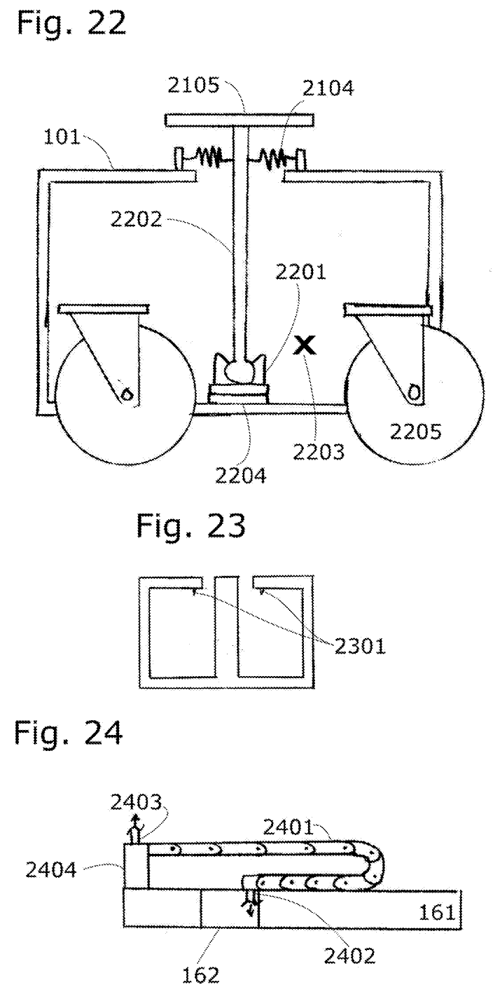

FIG. 22 shows a representation of a stability device that may be used with an enclosure;

FIG. 23 shows a representation of a device for directing water in the conduit;

FIG. 24 show a representation of a cable carrier; and

FIG. 25 shows a representation of an alternative conduit.

FIGS. 1 and 2 shows an example of an electricity collector device 100 attached to a vehicle 200 on a road surface 300. Vehicle 200 may be any electric vehicle, for example an electric car or an electric lorry. FIG. 1 shows a side view of device 100, whereas FIG. 2 shows a birds eye view of device 100 on a road surface 300.

Collector device 100 comprises a wheeled enclosure 101. Enclosure 101 houses a collector system for contacting an electricity supply rail. The collector system is described in further detail below. Enclosure 101 comprises pairs of flanged wheels 102, 103. Flanged wheel pairs 102, 103 comprise flanges which are configured to engage with slits 302, 303 in a road surface 300, to keep enclosure 101 fixed relative to an electricity supply rail below the road surface 300.

A power cable 104 connects the enclosure 101, and specifically the collector system in the enclosure 101, to the vehicle. The power cable 104 typically connects to a suitable connection point in the electrical power circuits of the vehicle 200, for example in parallel with the vehicle's battery. The vehicle may then utilise this power to run its motors and other devices. A battery charging circuit may also be supplied power to charge up batteries whilst the vehicle is being propelled. There are various options for supplying external power to a vehicle, for example it may be connected to directly power an engine of the vehicle 200. Power cable 104 may for example connect to an existing socket on the vehicle 200. Vehicle 200 may not have a battery and may be a hybrid electric vehicle, a combustion engine vehicle, a fuel cell vehicle or may be powered by any other energy source. In each case external supply of electricity may increase range, reduce emissions and power on-board devices like air conditioners or heaters.

Power usage from the current collector may be metered simply by the use of an electricity meter, which may transmit readings over a wireless communication or cellular communication network to central database. A GPS (Global Positioning system) module may validate metering. Automatic number plate recognition (ANPR) may validate usage by comparing vehicle registrations to a database of paying/authorised users and checking GPS data. A single sensor in the conduit may detect if a concealed current detector is being used in that area and used in combination with ANPR for validation of authorised use.

The enclosure 101 is removably attached to the vehicle 200 by vehicle connection arm 150. Vehicle connection arm 150 is one example of a possible vehicle connection. In the illustrated example, vehicle connection arm is configured to provide 6 degrees of freedom to the movement of enclosure 101 relative to vehicle 200. By allowing 6 degrees of freedom of relative motion, the enclosure 101 can be maintained optimally aligned with an electricity supply rail, even as the vehicle 200 itself moves around the road.

Vehicle connection arm 150 comprises a connection bar 151, pivoting joints 152, 153, 154, 155, 156 and slider rail 160. The connection bar 151 may be an extendible bar, for example the length of the bar connection 151 may be increased or decreased to optimise the position of the enclosure 101 on the road surface 300. This can help reduce congestion when vehicles are in slow moving traffic by using a shorter length bar at lower speeds.

Slider rail 160 connects the vehicle connection arm 150 to the vehicle 200, and comprises a fixed rail 161 attached to the vehicle 200, and a slider connector 162. Slider connector 162 is slidably attached to the fixed rail 161 such that the slider connector 162 can slide along the fixed rail 161 in a lateral direction compared to the direction of motion of the vehicle 200. Slider rail 160 provides a first degree of freedom to the motion of the enclosure 101 relative to the vehicle 200.

Slider connector 162 is attached to a series of two pivoting joints 152, 153. Pivoting joint 153 is in turn attached to a first end of the connection bar 151. Pivoting joint 152 allows the connection bar 151, and hence the enclosure 101, to rotate relative to a first rotation axis. Pivoting joint 153 allows the connection bar 151, and hence the enclosure 101, to rotate relative to a second rotation axis. The first rotation axis is perpendicular to the second rotation axis. In the illustrated example, the first rotation axis is substantially perpendicular to the road surface 300, whereas the second rotation axis is substantially parallel to the road surface 300.

The second end of connector bar is attached to a second series of pivoting joints 154, 155, 156. Enclosure 101 is attached to pivoting joint 156. Each of pivoting joints 154, 155, 156 allows the enclosure 101 to rotate relative to the connection bar 151 about a rotation axis, each rotation axis being perpendicular to the other rotation axes of the joints 154, 155, 156. In the illustrated example, pivoting joint 154 allows rotation about the second rotation axis—i.e. the same axis as pivoting joint 153. Pivoting joint 155 allows rotation about the first axis, i.e. the same axis as pivoting joint 152. Pivoting joint 156 allows rotation around a third axis that is perpendicular to both the first and the second axes. The third axis is generally aligned with the direction of travel of the vehicle 200.

The combination of slider rail 160 and pivoting joints 152-156 allows the enclosure to move with six degrees of freedom, so that movement of the enclosure 101 in directions other than the direction of travel is independent of the vehicle 200. In particular, the pivoting joints 152-156 can compensate for pitch, roll, yaw, horizontal and vertical movements of vehicle 200, whilst slider rail 160 allows lateral movement.

When enclosure 101 is in position on the road surface 300, each of the pivoting joints 152-156 and slider rail 160 allow free movement of the enclosure 300. Some or all of the pivoting joints may also be associated with one or more actuators (not shown), for example one or more electric motors, to forcibly move the enclosure 101. For example, in an initial position the enclosure 101 may be held above the road surface 300. When it is desired to connect the vehicle 200 to an electricity supply rail, the enclosure may be lowered onto road surface by actuating pivoting joint 153 and/or 154. The lateral position of the enclosure 101 may be controlled by actuating one or both of pivoting joints 152 and 155 and/or the slider rail 160. When connection to the supply rail is no longer needed, the enclosure 101 can be moved away from the road surface 300 by actuating one or both of pivoting joints 153, 154 in an opposite direction to that used to place the enclosure 101 on the road surface 300. Any of the actuators may for example then be actuated to move the enclosure 101 into a storage position. When the enclosure 101 is in position on the road surface 300, the actuators may be disengaged from the pivoting joints 152-156 to allow the joints to move freely. For example, a clutch may be used to disengage an actuator from its associated pivoting joint.

Cables or rods could also be used to actuate the arm without actuating the actual joints directly.

The device 100 also comprises a sensor system 170, such as an optical sensor system. The sensor system detects slits 302, 303 in the road surface 300, and controls the positioning of the enclosure 101 so that the enclosure 101 is positioned correctly on the road surface with the pairs of flanged wheels 102, 103 inserted into slits 302, 303. The sensor system may, for example, comprise a laser or plurality of lasers operable to scan a road surface 300 behind the vehicle 200; and a controller configured to process the location of slits 302, 303 determined by the laser and control actuators of the pivoting joints 152-156 to correction position the enclosure 101. Such a technique can utilise the reflection of the laser by the typically metallic surface, or the geometry, of the slits 302, 303 to detect when the enclosure 101 is correctly aligned relative to the slits.

The sensor system 170 may also be used to determine if the vehicle has moved too far away from the conduits for an electrical connection to be maintained. If the vehicle has moved further than a pre-determined distance away from the conduits, the controller of system 170 may control a retraction of the collector arm/s of the device 100, and may raise the device 100 above the road surface to disengage its wheels from slits in the road surface. This may particularly be the case if the vehicle changes lanes. The device 100 can then be repositioned over conduits in the new lane, and the collector arm re-inserted into the conduits to provide electricity to the vehicle.

An alternative or complimentary sensor system 170 may correlate the actions of the driver within the car and the enclosure. For example, a sensor may detect a driver indicating a desire to change lane and can then provide a signal to the enclosure to disengage the wheels from the slits in the road surface. Alternatively or additionally, sensors may monitor the input provided to the steering wheel (steering angle sensors are used in many vehicles) and compare the input to the current position of the wheels relative to the slits to determine whether to disengage the wheels from the slits. Accelerometers can also be employed for a further level of reliability, and to detect emergency scenarios, such as swerving suddenly.

In an alternative embodiment, a slider rail may be attached to a vehicle by a fixed bar, such that the slider rail is suspended above the road surface. The slider rail may comprise wheels for additional support. An enclosure containing the collector device may be attached to and able to slide along the slider rail. In this way the enclosure can move to maintain an electrical connection between the collector device and a supply rail as the vehicle moves, correcting for lateral movement of the vehicle by sliding on the slider rail. The slider rail may comprise a moving counterweight. The slider rail may carry sensors of the sensor system. The bar connecting the slider rail to the vehicle may be movable to raise or lower the slider rail (and enclosure). This movement may be actuated.

FIG. 3 shows a cross section of the enclosure 101 on the road surface 300 to illustrate how pairs of flanged wheels 102 and 103 engage with slits 302, 303 in the road surface 300. Each wheel comprises an inner section which rests on the road surface 300, and a flanged outer section which inserts into a slit 302, 303. Typically slits 302, 303 also define an entrance into conduits containing supply rails, into which a collector system housed by the enclosure 101 can be inserted, as described below. FIG. 4 shows a cross section of the enclosure 101, including a collector system 400. The collector system 400 is configured to collect electricity from supply rails located in conduits below the road surface 300, in order to supply electricity to the vehicle 200.

The collector system 400 includes retractable first and second collector arms 401, 402, and an actuation system 403. In the illustrated example, the actuation system comprises an actuated rack and pinion operable to lower the collector arms 401, 402 (only collector arm 401 is shown in FIG. 4) under the enclosure 101, and into a first and second conduit containing a first and second supply rail (described below). The dashed lines in FIG. 4 represent the collector arm 401 in the lowered state. Electricity collected by the collector arms 401, 402 passes into the power cable 104 and power the vehicle 200 (directly or indirectly), as described above.

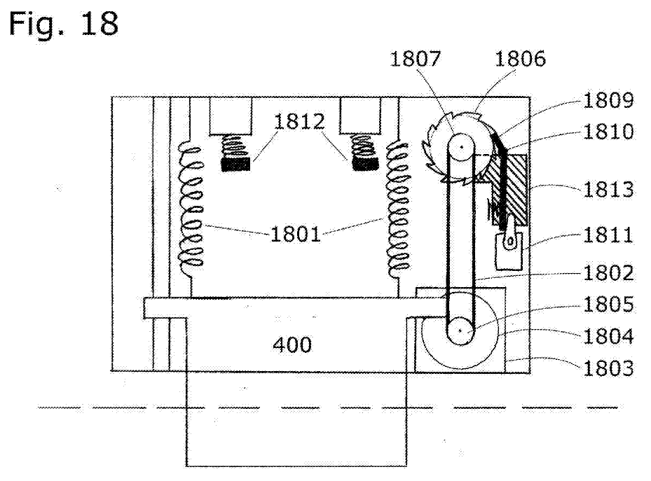

The actuation system 403 may be configured in many different ways. A belt and pulley drive may be used. Pneumatics may be advantageous in terms of speed and positional control and locking at end points. FIG. 18 shows a configuration in which the collector system 400 is spring loaded with springs 1801 and the collector system 400 is actuated with a belt (or chain) drive 1802. The belt drive 1802 is driven by an actuator for example a stepper motor 1803. Motor 1803 is connected to a freewheel mechanism 1804 or equivalent, that is in turn connected to the belt drive pulley 1805. A ratcheting mechanism 1806 is connected to a further belt drive pulley 1807. The ratchet has a sprung ratchet pawl 1809 that is able to pivot at 1810 and actuator 1811 may be used to quickly release the pawl from the ratchet teeth. The ratcheting mechanism allows extension of the springs 1801 without having to sustain the force to hold them. When the collector system 400 needs to be quickly retracted, the trigger pawl 1809 is disengaged and the belt drive is no longer locked by the ratchet mechanism. Tension in the springs 1801 retracts the collector system back into the enclosure 101 unhindered by the motor 1803 because the freewheel mechanism disengages its connection when rotated in this direction. A clutch, worm gear or clamping cam device could be used instead of a ratcheting mechanism, or the motor could be specified with sufficient holding torque.

Instead of spring 1801, a compression spring facing the opposite direction may be used, or an elastomer or clock/torsional spring may be used. Shock absorbers 1812 may absorb the impact of the collector system 400 as it reaches the top of its travel at speed. A counter weight 1813 may be made to move in the opposite direction to the collector system 400. In the example this is achieved by attaching counter weight 1813 to the other side of the belt drive 1802. The effect of counterweight 1813 is to reduce a resulting force on the collector device caused by the change in momentum of the collector system as it is quickly retracted and impacts shock absorbers 1812.

A lighter duty version of the above may be used for retracting the collector arms and such a mechanism can be fixed to the enclosure 101 rather than to the collector system 400. This may decrease the weight that has to be retracted, improving retraction speed. If this retraction mechanism is fixed to the enclosure 101, then motion has to be transferred to the collector system 400 for retraction of its collector arms. This may be achieved with a vertical rod that is moved horizontally by the retraction mechanism fixed to the enclosure 101. The collector system may then have a linear bearing that slides up and down the vertical rod during insertion and retraction of the collector, this linear bearing may be linked to the collector arms in such a way that applied horizontal movements of the vertical rod open and close the collector arms.

The particular design of the collector arms 401, 402 as shown is matched to the particular design of the conduits they are to be inserted into. It can be appreciated that different designs may have different conduits. FIGS. 5-7 show three different alternatives of conductor arms, matched to three different versions of conduits.

FIGS. 5a to 5c illustrate a first example of collector arms 501, 502 inserted into conduits 304, 306. Conduit 304 is formed by a plurality of walls: top wall 305a, side walls 305b, 305c, and bottom wall 305d. Similarly, conduit 306 is formed by top wall 307a, side walls 307b, 307c, and bottom wall 307d. Conduits 304 and 306 are substantially identical, and are arranged as mirror images of each other. Conduits 304, 306 are located below the road surface 300, with top walls 305a, 307a being substantially flush with the road surface 300. Slits 302, 303 are formed between the top walls 305a, 307a, and respective side walls 305b, 307b, and provide access into conduits 304 and 306 respectively. In alternative examples, the slits 302, 303 may be formed just in the top surfaces 305a, 307a, i.e. in the top surfaces but away from the side surfaces 305b, 307b.

An optional central section 320 connects the conduits 304, 306 together. Central section 320 may help reduce the stress on the top surfaces 305a, 307a, which due to the slits 302, 303, are cantilevered. The central section 320 may also provide maintenance access to the supply system, and may make short-circuiting of the two rails by fluids of foreign objects/matter much less likely.

Conduits 304, 306 also comprise drainage systems 351, 352, operable to drain water from the conduits.

Each conduit 304, 306 contains one or more electricity supply rail 308, 309 for supplying electricity to the collect system of the collector device 100. For example, one rail 308, 309 may be a live rail, and the other rail 309, 308 may be a neutral rail. For safety, the supply rails 308, 309 are positioned within the conduits 304, 306 as far away from the slit 302, 303 as possible. In the illustrated example, the supply rails 308, 309 are attached to the external side walls 305c, 307c. Keeping the supply rails 308, 309 away from the slits 302, 303 minimises the chances of a foreign object entering the conduits 304, 306 through the slits 302, 303 and making contact with the supply rails 308, 309. For example, the distance between the slits 302, 303 and the respective supply rails 308, 309 may be between 350 mm and 500 mm, for example 400 mm. Typical dimensions of each conduit may be, for example, a width of between 350 mm and 450 mm and a depth of between 350 mm and 450 mm. A central section between the two parallel conduits may have a width of between 50 mm and 300 mm. The width of the slits 302, 303 may ideally be less than 20 mm, so that the risk of a wheel of a bicycle entering the conduit is minimised, allowing the conduits to be used on roads also used by cyclists. On roads where cycling is prohibited, such as motorways, the slits 302, 303 may be wider. The collector arms may for example be adapted to be compatible with two different conduit systems, for example by inserting a thicker or thickened collector arm into the conduit, which may be able to conduct a larger current/voltage. Other considerations for determining the dimensions of the conduits include: ensuring it is impossible for someone to insert a hand into the conduit and reach a supply rail; ensuring it is geometrically difficult for the supply rail to be reached by a flexible object; minimising the conduit width to minimise cost and cantilever stress on the top surfaces 305a, 307a; and minimising depth to minimise cost. Alternatively, each conduit may contain two or more nested supply rails, one for high power collection and one for low power collection. For example, the high and low power rails may be separated by an insulating bar. The high power rail may be used, for example, only by high power vehicles such as lorries. The high power vehicles may have collection systems with collector arms adapted to reach the high power rail, whereas low power vehicles may have collection systems with collector arms adapted to reach the low power rail.

The collector arms 501, 502 are adapted to pass across the distance between the slits 302, 303 and supply rails 308, 309. Collector arm 501, which is identical to, but the mirror image of, arm 502, is shown in more detail in FIGS. 5b and 5c.

Collector arm 501 comprises an insertion rod 503. Insertion rod 503 is adapted to be inserted into conduit 304 through slot 302 in an insertion direction substantially perpendicular to the slot. A collector rod 504 is rotatably attached to the insertion rod 503. During initial insertion through slit 302, collector rod 504 is in a non-rotated position, lying flat with the insertion rod 504. In the illustrated example, the collector rod 504 when in its closed position is housed within a portion of the insertion rod 503 when in its non-rotated position.

Once the collector arm 501 has been lowered into conduit 304 far enough that all of the collector rod 504 is inside the conduit 304, the collector rod 504 can be rotated out of the plane defined by the insertion rod 503 (i.e. rotated about a rotation direction perpendicular to the insertion direction) in order to contact the supply rail 308. For example, the collector rod 504 may be rotated by substantially 90 degrees to contact the supply rail 308. The rotation of the collector rod 504 may be actuated by an actuator housed in the enclosure 101. For example, an actuator connector 505 may connect the actuator to the collector rod 504. For example, a flexible drive shaft may be used to actuate the collector rod 504.

The collector rod 504 comprises a conductive tip or brush 506 that can collect electricity from the supply rail 308, and transmit it back through the collector rod 504, through a power cable 507 and back to the enclosure 101. In the illustrated example, the tip 506 is pivotably connected to the remainder of the collector rod 504. In this case, the total length of collector rod 504, including the tip 506, is slightly larger than the distance between the insertion rod 503 and supply rail 308. As the collector rod 504 rotates to contact the supply rail 308, the tip 506 will come into contact with the supply rail 308 before the collector rod has rotated the full 90 degrees. Further rotation of the collector rod 504 forces the tip 506 to pivot in a direction opposite to the direction of rotation of the remainder of the collector rod 504. As shown in FIG. 5c, when rotation is complete the tip 506 has pivoted by substantially 90 degrees relative to the remainder of the collector rod 504, so that a long side of the tip 506 lies flat against the supply rail 308. This arrangement may provide an optimal electrical connection between the supply rail 308 and the connector rod 504. In alternative examples, the tip 506 may be rigidly attached to the rest of the collector rod 504, rather than pivotably attached.

FIGS. 6a-6d show an alternative conduit 304, and matching alternative collector arm 601. A corresponding conduit 306 and collector arm 602, identical to but mirror images of conduit 304 and arm 601, are not shown for clarity.

In this example, conduit 304 comprises a wedge-shaped bar of insulting material 350. Insulting bar 350 extends through the full length of conduit 304. The insulating bar is positioned between the slit 302 and supply rail 308, and is attached to the underside of top wall 305a. The insulating bar provides a physical barrier between the supply rail 308 and slit 302, to further limit the chance of foreign objects entering the conduit 304 and being able to contact the supply rail 308. Although in this example the insulating bar 350 is a wedge-shaped bar, any other shapes may be used, for example shapes with a rectangular cross-section.

In this example, the supply rail 308 is attached at the corner of the top surface 305a and side wall 305c. This ensures a maximal distance between the slit 302 and rail 308, as an object entering the slit 302 must pass around the wedge-shaped insulating bar 350 to reach the rail 308. Compared to the conduit shown in FIG. 5a, the conduit of FIG. 6a may advantageously be designed with a smaller cross-sectional area, without compromising on the distance between the slot 302 and supply rail 308—i.e. the dead space within the conduit of FIG. 6a may be less than that within the conduit of FIG. 5a. Furthermore, in the conduit of FIG. 6a an object must follow a more complicated path to reach the supply rail 308 than in the conduit of FIG. 5a, further reducing the likelihood of foreign objects being able to fall into the slit 302 and contact the supply rail 308.

In order to manoeuvre around the insulating bar 350, the collector arm 601 unfolds within the conduit 308 in two stages. This process is illustrated in FIGS. 6b-6d. Collector arm 601 comprises an insertion rod 603 and a collector rod 604, similar to insertion rod 503 and collector rod 504 respectively. However, unlike insertion rod 503 and collector rod 504, collector rod 604 and insertion rod 603 are not directly attached to each other. Instead, a support bar 607 is rotatably attached to insertion rod 603. Collector rod 604 is in turn rotatably attached to the support bar 607. In the illustrated example, the collector rod 604 is housed within a portion of the support bar 607 when in the unfolded position. In alternative examples the collector rod may not be housed within the support bar—i.e. the support bar and collector rod may be adjacent to each other. Rotation of the support rod 607 and insertion rod 604 may be driven by an actuator housed in enclosure 101, via an actuator connector (not shown) similar to actuator connector 505. The actuator may for example be a flexible drive shaft.

FIG. 6b shows the collector arm 601 in the unfolded position. In this position, collector arm 601 may be inserted through a slit 302 into a conduit 304, in particular into a conduit 304 as shown in FIG. 6a.

Once the unfolded collector arm 601 has been fully inserted into the conduit 604, for example deep enough into conduit 604 for the bottom of the insertion rod to be approximately level with the bottom of the insulating bar 350, the support bar 607 and collector rod 604 can be unfolded. In a first stage, shown in FIG. 6b, the support bar 607 is rotated out of the plane defined by the insertion rod 603 (i.e. about a rotation direction that is perpendicular to the insertion direction). The support bar may for example be rotated by between 45 degrees and 90 degrees, depending upon the design of the conduit 304. The collector rod 604, housed within the support bar 607, also rotates as the support bar 607 is rotated.

FIG. 6d shows the second unfolding stage. With the support bar 607 in the rotated position, the collector rod 604 is rotated out of the plane defined by the support bar 607 (i.e. collector rod 604 is rotated about a direction that is substantially perpendicular to the insertion direction and to the rotation direction of the support bar 607). The collector rod 604 may for example be rotated by between 30 and 150 degrees, until contact is made with the supply rail 308.

In alternative examples, the collector rod 604 may be rotated about a direction that is substantially parallel to the to the rotation direction of the support bar 607. For example, the collector rod 604 may be attached along its long edge to the support bar 607, rather than at a short edge as shown in FIGS. 6b-6d.

Similar to collector rod 504, collector rod 604 comprises a conductive tip 606 that is pivotably attached to the remainder of the collector rod 604. Tip 606 acts in the same way as tip 506, pivoting upon contact with the supply rail 308 to increase the contact area between the collector rod 604 and the supply rail 308. Electricity collected from the supply rail 308 may be transmitted to the enclosure 101 via a power cable (not shown), similar to power cable 507.

Another alternative conduit 304 and matching collector arm 701 is shown in FIGS. 7a-7d. FIG. 7a shows a collector arm 701 inserted into a conduit 304. A corresponding conduit 306 and collector arm 702, identical to but mirror images of conduit 304 and arm 601, are not shown for clarity.

In this example, the conduit 304 again comprises an insulating bar 350 extending from the top wall 305a. In this example, insulating (or earthed non-insulating) bar 350 is an elongate bar with a thin rectangular cross section, located adjacent to the slit 302. Insulating bar 350 separates the slit 302 from the supply rail 308, similar to the insulating bar 350 of the conduit shown in FIG. 6a. In this example, the supply rail 308 is attached to the underside of top wall 305a.

FIGS. 7b and 7c show a collector arm 701 that may be used to contact the supply rail 308 shown in FIG. 7a. Collector arm 701 comprises an insertion rod 703 and a collector rod 704. The collector rod is rotatably attached to the insertion rod. The collector rod comprises a first section 708 that extends outwards from the insertion rod 703, in a direction that is substantially perpendicular to the length of the insertion rod 703. The collector rod 704 further comprises a tip section 706 that is fixedly attached to the end of the first section 708. The tip section extends upwards from the first section 708, in a direction that is substantially parallel to the length of the insertion rod 703. The tip section 706 comprises a contact brush for contacting the supply rail 308.

The collector arm 701 may be inserted into a conduit 304 through a slit 302. Initially, the collector rod 704 is not rotated, so lies in the same plane as the insertion rod 703. This allows the collector rod 704 to be inserted through a narrow slit 302. The collector arm is inserted into the conduit 304 to at least a depth where the uppermost edge of the tip 706 of the collector rod 704 lies below the lowermost part of insulating bar 350.

After the collector arm 701 has been inserted into the conduit 304 to the desired depth, the collector rod 704 can be rotated to extend under the insulating bar 350, as shown in FIG. 7c. The collector rod 704 is rotated about a rotation direction that is parallel to the insertion direction. The collector rod 704 is rotated by between 45 and 135 degrees, for example by 90 degrees.

After rotation of the collection rod 704, the collector arm 701 is partially retracted from the conduit 304, so that the tip 706 of the collector rod 704 is drawn upwards and makes contact with the supply rail 308, as shown in FIG. 7a.

One example of how the collector arm 701 can be inserted into a conduit 304 is shown in FIG. 7d. When not in use, the collector arm is housed within enclosure 101. The end of the insertion rod 703 that is not attached to the collector rod 703 is rotatably attached to the enclosure 101 at a rotation point 710. To insert the collector arm 701 into a slit 402, the collector arm is rotated about the rotation point 710, rotating the collector arm 701 down into the slit 302. The rotation may be actuated by an actuator within the enclosure, or a clutch or brake may be disengaged and the collector arm allowed to swing down under its own weight.

In an alternative example similar to collector arm 701, the insertion rod 703 and collector arm 704 may be fixedly attached to each other. Instead of rotating just the collector arm 704 to contact the supply rail 308, as in FIG. 7a, both the insertion rod 703 and the collector arm 704 may be rotated after insertion into a conduit 304. For example the insertion rod 703 and the collector arm 704 may be rotated by an actuator in the enclosure 101.

An alternative mechanism for moving brushes outwards to contact the conductor rails is shown in FIGS. 16a (a plan view from above) and 16b (a side view facing in the travel direction). FIGS. 16a, 16b, show a conductor rail 1604. Two arms 1601a and 1601b are offset above and below the current collector brush 1602 to facilitate compact storage when the brush is retracted, i.e. for some dimensions of arm length and brush length the arms may interfere if placed in line. The arms are also offset so that they hinge at different points on the length of the collector brush, this allows parallel motion if the arms are actuated equally. Electrically connecting the brush to a the collector system 400 to receive power from the rails is very convenient and may be achieved with a flexible cable or flexible flat copper strips, for example, and no rotational electrical joint is needed. This configuration (FIG. 15a,b) is advantageous because a brush of unlimited face length or face width can be used while also being compact, and stored thickness 1603 can be kept small regardless of surface area of the brush (meaning the conduit slit can be kept thin). Conventional collector brushes that used for third rail locomotive applications may be compatible with this configuration.

Another advantage is the resultant parallel motion will allow a uniform pressure to be exerted over the face of the brush, meaning even wear and better electrical connection. If the collector device or brush profile is not exactly parallel with the rails, independent spring loading of the each arm or its actuator will compensate for this. Another important advantage is that the brush can wear through all or the majority of its thickness because rotating arms 1601a, 1601b, never come into contact with the conductor rail 1604, and instead can extend past it, this means brushes will last longer for the same stored thickness 1603.

FIGS. 16a, 16b further show a roller bearing 1605. Roller bearing 1605 is not limited to the arm extension mechanism shown by FIGS. 16a,16b and can be integrated into other expanding arm mechanisms. FIG. 16a shows the ramped top surface 1606, this allows the arm to reliably engage with the conductor rail without catching (being stopped by) on the bearing surface 1607 that is an additional part of the conduit. For example it may be fixed to the top surface 305a of the conduit 304 shown in FIG. 5a. The slope 1606 on the surface of the arm may be be skewed to compensate for the variably angled interface when the arm is initially extending past the bearing surface 1607 in sliding contact, ensuring that the arm 1601a does not dig into the bearing surface and the sliding surfaces are reasonably parallel. When engaged, the roller bearing 1605 prevents upward movement and works in combination with the flanged wheels to constrain all displacement modes of the collector device relative to the conduit keep perfect alignment of the brushes to the rails. The roller bearings prevent upward movement and make the collector device more robust against misalignment while brushes are engaged with the rails, for example when bumps and dips in the road are encountered. The constraining effect of the rollers mean that the collector device does not have to necessarily be forced down as heavily (or at all) onto the road using a spring-damper or other means. Rotation is also constrained (particularly if the collector system 400 comprises of two brushes extending in opposite directions) meaning the collector device/enclosure does not have to maintain balance.

In any of the above examples, the collector arm may for example be actuated by a flexible drive shaft. Rotating the flexible drive shaft may cause the collector rod, and where applicable, support bar, to rotate. The rate of rotation of the joints may be optimised to keep the conduit small, and ensure that the supply rail is hard to access. Bevel gears at the rotation joints or a cable system may also be used to transfer force around the small and tight corners allowing reliable actuation externally. Very small electric, hydraulic or pneumatic actuators may also be used directly at the hinges.

FIGS. 17a (back) and 17b (side view) show an alternative embodiment of a device that is used to detect foreign objects in the conduit 1712 that can cause damage to the collector device by obstructing its path or even resulting in tearing the unit off the vehicle and possibly adversely affecting the motion of the vehicle.

The device is generally separate to the collector device and may be installed at the front (or in front) of the vehicle. A sliding rail 1701 is used that allows the deviations of the vehicle from the conduit and can also be used for positioning. Alternatively a rotatable/swinging arm can be used to allow sideways displacement which can be connected easily to the towing eyelet, bumper or other feature on the front of a typical vehicle. A pad 1702 is provided that is profiled to physically interfere with all possible obstructions that can affect the collector device. In the example shown, pad 1702 is suspended from the sliding rail on a rotating joint 1703, which means that any encountered obstruction will cause it to swing backwards and upwards allowing the obstruction to pass.

In this embodiment the swinging is sensed by a positional/rotational sensor located in joint 1703, a magnetic switch, or otherwise. The signal from the sensor triggers the control system to immediately retract the current collector device from the conduit as quickly as possible. Gravity or a light spring can then be used to reset the position of the pad 1702.

Roller wheels 1704 mean the pad 1702 is not worn as it attempts to engage with the conduit. This ensures that actuating the sliding rail or controlling vehicle steering can be used naturally engage the pad assembly with the conduit, even using trial and error. The flanged roller wheels 1705, allow tracking of the conduit slit without abrading the pad. Actuation will be needed to retract the pad 1702 when deviations from the conduit become too large, and when the collector device is not being used. A sweeping brush 1706 may be used to help keep the conduit and the pad free of debris. As an alternative the pad can be flexible and may be provided with means of detecting the flexure. In this instance a rotating joint may be not needed.

In an embodiment as shown in FIG. 17a, a mounting bracket 1707 connects to the vehicle and expanding bellows 1708 are provided to keep the sliding rail clean and free of debris. On FIG. 17b, reference numeral 1713 is the top of the conduit slit that is substantially flush with the road surface, numeral 1710 represents the position of pad 1702 when attempting to enter the conduit, numeral 1711 represents the pad's stored position and numeral 1709 is the direction of vehicle travel.

The pad detector system shown in FIGS. 17a-b should be engaged with the conduit before the collector device is engaged. This allows the sliding rail 1701 to be used as a positional encoding to feedback an accurate real time position of the conduit relative to the vehicle. This can be used to assist the conduit engagement of the collector device. Using this system as a positional detector can not only provide accurate position information, but may be able to facilitate a quicker reaction time to detect undesired deviation of the vehicle from the conduit, meaning retraction of the current collector can be faster (this is because most vehicles steer from the front). It is likely the pad will need light spring loading to resist movement due to air resistance/drag and prevent oscillations caused by the vehicles motion.

To further mitigate problems arising from obstructions in the conduit slit, a plough can be used that is to be the collector device or separately on another part or integrated on sliding rail 1701 with the detector pad 1702. This plough can be inserted into the conduit slit during the engagement phase. If the plough meets any obstructions from debris jammed in the conduit slit, these obstructions will be forcefully pushed or wedged out of the way, allowing the collector device to follow without hindrance. The geometry of the plough will include an upward facing ramp/slope that will wedge debris upward and out of the way as it meets them. The plough and its attachment will be strongly built (e.g. from steel) but there is chance that obstructions could be to resistant to the plough, in this case spring loading or other resistance means (including magnets or cams) can be used such that at a certain force of impact, the plough will retract, preventing damage or hindrance to the attached vehicle or collector device. The retraction of the plough can be sensed in a similar way to the detector pad 1702, to signal retraction of the collector system 400 from the conduit. The plough may be combined and integrated with the detector pad 1702 shown in FIGS. 17a-b.

A laser scanner at track level can be used to see obstructions that are ahead of the vehicle. Computer vision or scanning sensors (such as LIDAR or sonar) aimed down the road ahead can detect obstructions that are visible from the surface of the road.

In any of the above examples of conduits comprising an insulating bar 350, the conduits may further comprise rollers to aid movement of a collector arm along the conduit. For example, the bottom side of an insulating bar 350 may comprise rollers that allow motion along the conduit. The support bar 607 or part 708, of a collector bar 704 may slide along the rollers. Alternatively rollers may be included on the collector arm to facilitate sliding along a flat surface of the conduit.

In any of the above examples of conduits, additional features may be used to further limit the chance of foreign objects making contact with the supply rails. One example is shown in FIG. 8. FIG. 8 shows a pair of conduits 304, 306. Conduits 304, 306 may be any of the conduits described above. In particular, the features of FIG. 8 may be useful when matched with conduits comprising an insulating bar 350 extending from the underside of the top wall 305a.

In FIG. 8, the conduit 304 comprises a plurality of fins 360a-c extending from the bottom wall 305d. Any number of fins may be used, including only one fin. The fins 360a-c limit the vertical space under the insulating bar 350 through which an object must pass to reach the supply rail 308. Further, the fins 360a-c may prevent flat objects such as leaves that have fallen through slit 302 from curling upwards and making contact with the supply rail 308. The fins 360a-c may therefore increase the safety of the supply system.

In any of the examples described above of a pair of conduits, the conduits in the pair do not need to be symmetrical. Some features may be included in only one of the pair of conduits. For example, in FIG. 8, only the conduit 304 comprises fins 360a, 360b, 360c and only that conduit is shaped to fit the fins 360a-360c in. The second conduit 306 does not have fins 360a-c, and is has a smaller cross-section area. This arrangement may be used, for example, where conduit 304 contains a live supply rail, and conduit 306 contains a neutral supply rail, the neutral supply rail requiring fewer safety precautions. Using a neutral rail may reduce the risk of stray currents and electrochemical or galvanic corrosion.

Any conduits 304, 306 may also comprise a foreign object detection system to detect any object other than a collector arm that enters the conduit 304, 306. The detection system may be configured to cut of the supply of electricity to all of, or a section of, a supply rail 308, 309, when a foreign object is detected in a conduit 304, 306. For example, the detection system may comprise an infra-red optical system for detecting foreign objects in the conduits 304, 306. More complicated systems can include for example: a wired connection (communication through the mains rails, or otherwise), wireless (e.g. radio, internet of things network) communication, and/or camera traffic monitoring/computer vision (including integration with an existing smart motorway), to authorise a vehicles use of the conduit and therefore detect foreign objects.

The foreign object detection system may also comprise a vehicle detection sensor in the road surface, such as inductive loops in the road surface. For example, a vehicle detection sensor may be used in addition to an optical sensor in the conduit. If the optical sensor detects an object in the conduit, but the vehicle detection sensor does not detect a vehicle on the road surface above the conduit, then it can be determined that the object in the conduit is a foreign object, which may be hazardous. A section of the supply line around the object may be shut down to prevent current flowing through the object and out of the conduit. Such a system may advantageously reduce the number of switches and use of switching required compared to conventional safety systems.

Any conduits 304, 306 may also comprise an earth rail, for example located close to the supply rail 308, 309. If a foreign object does make contact with the supply rail, it is likely to also make contact with the close earth rail, so that electricity safely flows to earth. The earth rail may also be part of the walls forming the conduit such as the top surface near the slits.

All of the above examples comprise a pair of conduits 304, 306, containing a pair of supply rails 308, 309. However, some examples may comprise only a single conduit. For example, two supply rails may be located in one conduit. A single collector arm with two collection rods, or two collector arms inserted into the same conduit, may be used to contact the supply rails. Alternatively the system may comprise only a single supply rail in a single conduit. For example the collector device may be connected to an alternative return/neutral line. A plurality (i.e. two or more) of supply rails within each conduit is may also be used. In this case, the collector rods may be adapted to contact the plurality of supply rails, or further collector rods may be added to the collector system to contact the additional supply rail. Alternatively, further parallel conduits containing one or more supply rails may be used. Such examples may be used to produce a three-phase electricity supply for three-phase AC motors. In a further example, multiple supply rails with (and matching multiple collector rods) may be used in tandem to increase the total current drawn from the system. This may be particularly useful if, for example, the geometry of the system limits the current that can be carried in a single collection arm.

The supply conduits do not have to be continuous, conduits may be intermittent (short sections, with gaps). This may be more cost efficient. Intermittent systems may be located where vehicle are slowing down or stopping often, meaning more contact time is possible for the same conduit length. Energy may be stored rapidly using very fast battery chargers, a capacitor or any other means, and this stored energy may compensate for the lack of power supply between the intermittent conduit gaps.

Stationary conduits may be used at bus stops, for example. Such stationary conduits may have sufficient length so that buses can queue, and so that positioning is easier. Lengths of conduit may be installed along parallel parking bays or taxi ranks. In addition the system may be used for stationary/parked vehicles, for example very small conduits segments may be installed in car parking bays. The collector device may automatically locate itself and make a connection for stationary charging of batteries. For example, the user may only need one collector device for both stationary charging (without the use of inconvenient cables) and for dynamic power transfer on the roads. FIG. 9 shows an alternative vehicle connection 950 that may be used to connect an enclosure 101 to a vehicle 200.

Vehicle connection 950 comprises a slider rail 960, similar to slider rail 160. Slider rail 960 comprises a fixed rail 961 attached to the vehicle 200, and a slider connector 962. Slider connector 962 is slidably attached to the fixed rail 961 such that the slider connector 962 can slide along the fixed rail 961 in a lateral direction compared to the direction of motion of the vehicle 200. Slider rail 960 provides a first degree of freedom to the motion of the enclosure 101 relative to the vehicle 200, and may be actuated for precise alignment with the power supply.

A vertical connector 951 is pivotably attached to the slider connector 962 by pivoting joint 952. Vertical connector comprises a means to raise and lower the enclosure 101 vertically relative to the road surface 300. For example, the vertical connector may comprise one or more linear actuators and/or resilience means such as a spring, as in the illustrated examples. The resilience means may for example act as a shock absorber for vertical motion. Double wishbone suspension can also be used and cab give parallel constraint be more stable. Pivoting joint 952 allows the vertical connector 950, and hence also enclosure 101, to rotate relative to a first rotation axis.

The enclosure 101 is attached to the vertical connector 951 via a universal joint 953. Universal joint 953 comprises a pair of hinges 954a, 954b located close together, which are oriented at 90° to each other, and connected by a cross shaft. Universal joint 953 allows enclosure 101 to pivot relative to the vertical connector 951 about a second and/or third rotation axis. In the illustrated example, both the second and third rotation axes are substantially orthogonal to the first rotation axis. Universal joint 953 may be connected to one or more actuators, so that the position of the enclosure 101 relative to the vertical connector 951 can be controlled.

As shown in FIG. 9, the pairs of wheels 102, 103 of the enclosure 101 may comprise a suspension system 902 to cushion the impact of contacting the road surface. For example, the wheels 102, 103 may be sprung wheels comprising a spring to absorb the impact. A suspension system may also be used in the enclosure 101 shown in FIG. 1. For the example shown in FIG. 9 or any of the embodiments of trailing units, instead of suspending above the road surface before and after engagement, the unit may comprise one or more supporting wheels. Swivel caster wheels may be particularly suited for the application because they can swivel to allow movement the trailing unit or enclosure 101 in any direction including in reverse and when the vehicle is turning sharp corners. Swivel casters may be particularly advantageous because they may allow the unit to move sideways along the sliding rail without dragging along the road surface whether the vehicle is moving or not. Any suspension that the wheels may have either from the tyres for from added suspension, may mean that the inserted collector system (400) will need to allow the resulting up and down movements, this may be achieved simply by spring loading the insertion mechanism so that the spring extends of retracts to keep the flanged wheels in constant contact with the conduit slit.

FIG. 10 shows an alternative example of the vehicle connector 950, which uses cables 1001a-d to lock the position of the universal joint 953, for use for example when the enclosure 1010 is being deployed or is stored. Cables 1001a-d are attached to the enclosure 101 with an angular separation of approximately 90 degrees (for example between 80 degrees and 100 degrees) between each cable connection. The cables 1001a-d are fed through corresponding pulleys 1002a-d on the vertical connector 951, and are attached to a linear actuator. When the linear actuator 1003 pulls the cables upwards—i.e. away from the enclosure 101, the cables are pulled tight, holding the position of the enclosure 101 fixed relative to the vertical connector 951. When the linear actuator 1003 moves down towards the enclosure, the cables slacken, and the universal joint 953 allows the enclosure 101 to move relative to the vertical connector 951.

In alternative examples of vehicle connector 950, one or more resilience means may be used in place of the universal joint 953. For example, one or more springs or rubber/polymer cushions could be used to allow limited motion of the enclosure along or about the second and third rotation axes. Alternatively, resilience means may be incorporated into the universal joint 953, to provide a restoring force to reposition the enclosure 101 relative to the vertical connector 951.

The above examples of vehicle connections 950 may advantageously provide a more compact collector device, without a long connection arm such as arm 151. The vehicle connections 950 may be particularly suited to situations where the vehicle travels substantially parallel to the slits in the road surface 300.

It may be important that the trailing unit is prevented from bouncing causing displacements relative to the road surface. This may be achieved using a spring and/or a damper or any means of applying a driving force onto the road (which may include the weight of the unit itself). This may be achieved using a parallelogram linkage with a linear spring attached at an angle which causes compression as displacement occurs (this is similar to, or the same as double wishbone car suspension). This type of linkage is advantageous because the desired placement of the trailing device is parallel or near parallel to the road surface, so using a parallel linkage means less reliance on additional actuation and small angular displacements can be controlled using smaller fine tuning actuators or using spring loading. This may be extended further by creating constrained parallel motion in both vertical and horizontal directions. To achieve this three linkage arms may be used (four or other numbers may also be possible), each with ball joints (or universal joints) on each end. Parallel motion in the vertical direction may be affected by the spring/damper due to its component of angular offset relative to the linkages within the vertical plane of motion, but because there is no component of angular offset in the horizontal plane of motion, movement is not affected by the spring/damper.

FIG. 15a shows an alternative vehicle connection. Vehicle connection points 1501 are attached to the vehicle body or axle assembly 1502 which may be integrated within the space below the vehicle or attached in a trailing fashion (e.g. attached to a tow bar), which may allow retrofit across dissimilar vehicles. Ball joints 1504 on the linkages 1503 are attached to three vehicle connection points 1501. The linkages are in turn connected to three enclosure connection points 1505 by the ball joints 1506 on their other ends. Enclosure connection points are located on the collector device's enclosure 101. The geometry of the linkages and connection points is such that only parallel motion is allowed. The spring/damper 1507 is attached to the vehicle connection points and the enclosure connection points with ball joints 1508 at a displaced angle to the linkages as explained above. The spring/damper 1507 is also able to attach one or both of its ball joints 1508 to locations on the linkages 1503 themselves or to locations constrained by placing a jointed linkage to bridge/straddle/span two linkages, hence allowing a shorter spring to be used.

Also shown in FIG. 15a is a linear actuator 1510 used for lifting the enclosure 101 from the road surface when not in use. Actuator 1510 may be suspended from above, ether attached to the underside of the vehicle or otherwise (e.g. the tow bar). This linear actuator 1510 can allow sideways and other displacements of the enclosure 101 through any or a combination of rotating joints or ball joints and a sliding rail 1511, either of which can be actuated or locked in a default position. The linear actuator 1510 uses lost motion meaning which allows sideways displacement if a rotational joint is used. More importantly, the lost motion allows movement in a telescopic manner as the collector device is displaced upwards and downwards e.g. over bumps in the road. FIG. 15b shows as cross sectioned portion of the actuator 1510 that allows lost motion and telescopic compression and retraction. The example is similar to the cross section of a cylinder and piston. A pneumatic cylinder may also be used to achieve a similar result. Note that a double wishbone suspension assembly or the triple linkage explained above may be attached to a sliding rail similar to the configuration in FIG. 9 (instead of being fixed to a part of the vehicle, 1502 as shown in FIG. 15a) to facilitate or increase the allowable sideways displacement of the collector device.

Locking the collector in a fixed position (with respect to the vehicle) can allow for the slit to be aligned with the collector using the vehicles own steering control manually, or by the vehicles own means of automation instead of using actuators. This method of positioning the collector device with the vehicle's steering is also possible for all other collector configurations/connections, whether suspended off the road or not. Even if automatic steering is used to align the vehicle, it is typically only required for the engagement phase and does not have to rely on communication or any compatibility between the vehicle and the add-on device in question. It is likely that if automatic or autonomous steering is used to align and engage the current collector device, the vehicle systems may have to be engineered to sense the conduits location or infer its position from existing or additional road markings. The final position can be fine-tuned by the collector device's own actuation. This means that cross-compatibility is easier as the collector device is independent of the vehicle systems, even if information is read from the vehicle electronics (data bus).

FIG. 19 shows another alternative vehicle connection. Similar to the configuration example in FIG. 9, a fixed rail is used and slidably attached to the rail is the slider 962 to allow the first degree of freedom in the lateral direction compared to the travel direction of the vehicle. Other joints for further degrees of freedom are not shown on FIG. 19 and will be similar to other examples already mentioned. A rotational joint 1901 is shown in the figure, this joint is for both moving collector system 400 towards the road surface and inserting it into the conduit slit. The default, unengaged position is shown by 1902 and the engaged position is shown as 1903. As the joint 1901 rotates for engagement, the pairs of flanged roller wheels 1905, 1906, (similar to 102, 103 in other examples) make contact with the conduit slit at the road surface 1907. The spring suspension 1908, possibly including a damper, may allow vertical up and down movements of the vehicle may apply downward force. Spring suspension 1908 is longer than is needed to reach the road surface, even in the case that the vehicle is at its highest anticipated position due to bounce. Consequently the length of 1908 ensures that there is always downward force applied to flanged roller wheels 1905, 1906, keeping the collector system 400 in contact with and in alignment with the conduit.

If engagement with the conduit slit is not successful due to misalignment, the point 1904 will contact the road first, this area can be fitted with a small roller wheel to prevent wear and abrasion of the collector system 400, and a sensor (such as a pressure switch or proximity sensor) can be used to signal the system to re-attempt the engagement.

In another embodiment, a fail-safe system may be used to abandon the collector system 400 in a worst case scenario, so that damage to the rest of the on vehicle device and vehicle do not occur, and the vehicle is not caused to crash. This fail safe may comprise of shear pins or similarly weakened points to cause breakage under force. Explosive charges like those used in car airbags and spring loading could also be used. The fail-safe typically includes an electrical socket, or weakened point so that cables from the collector arms can also separate. Magnetic coupling may also be used to achieve a similar effect. It can be appreciated that this fail-safe system may be utilized with any described embodiment.

FIG. 20 illustrates a torsional joint 2001 used as a means of resilience, suspension and downward force may also be used in addition to those described above and herein. Not limited to torsional resilience, FIG. 20 also illustrates that mounting the trailing unit or enclosure 101 behind the wheels of the vehicle 200 may make the vehicle shorter, which may be advantageous.

FIG. 21 shows a vehicle connection bracket 2101 attached to enclosure 101 that allows one of the degrees on freedom (in this case pitch in the travel direction, or alternatively could be roll) via the pivot 2102. This is intended so that the axis of this degree of freedom is below the centre of gravity 2103 of the trailing enclosure 101 and also so that the pivot is forward from the centre of gravity 2103. This may offer better dynamic stability for example during harsh acceleration or deceleration of the vehicle. Spring loading 2104 helps maintain a central default position. The top part 2105 connects to the vehicle via the rest of the vehicle connection assembly, which can be similar to the examples herein.

FIG. 22 shows an alternative way of increasing stability by lowering pivot points. A ball joint 2201 is used to provide two degrees of rotational freedom (or potentially three), this joint is below the centre of gravity 2103. Rotational joint 2204 allows a further rotational degree of freedom, and this joint may be actuated and controlled to allow precise adjustment to achieve parallel alignment to the conduit slits. Shaft 2202 connects the ball joint to a top section 2105 outside the enclosure 101 for connection to the vehicle via the rest of the vehicle connection assembly. The collector system may have to be modified to allow space for this shaft to move. Spring loading 2104 helps maintain a central default position. Swivel caster wheels 2205 are an example of supporting wheels which may be used on any of the trailing device embodiments.

The shape of the conduits described above is designed to limit the risk of foreign objects falling into the conduit and making contact with the electrical supply rail. This risk can be further limited by placing a guard across the slit in the conduit. FIGS. 11 and 12 show an example of a guard that can be used.

FIG. 11a shows a guard 1100 across a slit 302 leading to a conduit, such as conduit 304. The guard 1100 comprises a first cover 1101 and a second cover 1102. The first 1101 and second 1102 covers extend across opposite sides of the slit 302, and meet above the slit 302. The covers 1101, 1102 form a seal where they meet, preventing foreign objects from entering the slit.

The first 1101 and second 1102 covers can be forced apart to provide access to the slit 302, as shown in FIG. 11b. In particular, the collector arm of a collector device may be inserted between the first 1101 and second 1102 cover, prising or unzipping the covers 1101, 1102 apart so that the collector arm can enter the conduit through slit 302. Steel rails 1103, 1104 are provided on the edges of the first 1101 and second 1102 covers respectively. The rails 1103, 1104 limit the wear on the covers 1101, 1102 when a collector rod moves through the guard 1100.

Each of the first 1101 and second 1102 covers may comprise a composite of two or more materials, layered to provide a spring action. In the illustrated example, the covers 1101, 1102 comprise an upper layer 1105 and a lower layer 1106; the upper layer 1105 having a greater stiffness than the lower layer 1106. This arrangement provides a spring force which ensures the covers 1101, 1102 return to a closed position when not being forced apart. The upper layer 1105 may be segmented to accommodate the local deformation caused by the opening of the guard 1100. For example there may be peaks and troughs in the distance the upper layer 1105 extends across the cover, as shown in FIG. 11c.

FIG. 12 shows how a collector arm 1201 can move through the guard 1100. Collector arm 1201 may be any of the collector rods described above. When the collector arm 1201 is initially inserted into the conduit through the guard 1100, the first 1101 and second 1102 covers are prised apart by the collector arm 1201. As the vehicle to which collector arm 1201 is attached moves forward, the collector arm is pulled along the conduit, in the direction indicated by arrow F. The moving collector arm 1201 prises apart the covers 1101, 1102 ahead of it. The spring force of the covers 1101, 1102, closes the guard 1100 behind the collector arm 1201, preventing foreign objections falling to the conduit. Rollers 1202 on the collector arm 1201 interact with the rails 1103, 1104, so that the collector arm 1201 can move along and prise open the guard 1100 with minimal friction. Although four rollers 1202 are shown in the figure, any number of rollers 1202 may be used.

Alternative enclosures are possible. FIG. 13 shows an alternative enclosure 1301 which may be attached to a vehicle by a vehicle connection bar 1306, similarly to a conventional trailer. The collector device 1302 can move within the enclosure 1301 to compensate for movement of the vehicle and so maintain an electrical connection to a supply rail in a conduit 1304, 1305. In particular, the collector device 1302 can move laterally inside the enclosure 1301. The collector device 1302 may also be able to rotate within the enclosure 1301, or otherwise adjust its pitch, yaw, or roll to compensate for vehicle movement. In this example, the wheels 1303 of the enclosure are non-flanged, and are configured to run on the road surface. The enclosure 1301 is typically wider than the enclosure 101, to provide space for the collector device 1302 to move laterally within the enclosure 1301. In particular, enclosure 1301 may be substantially the same width as the vehicle to which it is attached,

A further alternative enclosure 1401 is shown in FIG. 14. In this example the enclosure 1401 is similar to enclosure 1301. Enclosure 1401 is attached to a vehicle by a vehicle connection bar 1406, and comprises wheels 1403, similarly to a conventional trailer. However, instead of moving just within the enclosure 1401, the collector device 1402 is able to extend laterally outside of the enclosure 1401. For example, supply rail containing conduits 1404, 1405 may be placed at the side of a road surface. A vehicle may pull the enclosure 1401 along the road next to the conduits 1404, 1405. When the collector device 1402 is to make contact with the supply rails, it extends out from the side of enclosure 1401, so that at least part of the collector device 1402 is suspended above the conduits 1404, 1405. Collector arms can then be deployed to contact the supply rails in the conduits 1404, 1404. For example, the collector device 1402 may comprise a telescopic bar (represented by the part dotted lines in FIG. 14) which can be used to extend the collector arms outside of the enclosure 1401. Once contact to the supply rails has been made, the collector device may be free to move laterally with respect to the enclosure 1401 to correct for lateral movements of the vehicle.

In any of the above examples of a collector device, the enclosure 101, 1301, 1401 may comprise an actuated wheel or wheels which can steer the enclosure 101, 1301, 1401. For example, the actuated wheel may be located at the back of the enclosure (i.e. the other side of the enclosure 101, 1301, 1401 from the vehicle). Alternatively or additionally the enclosure 101, 1301, 1401 may comprise one or more coasting wheels located at the back of the enclosure, the coasting wheels being free to rotate around an axis perpendicular to the road surface to follow any path on the road surface. The actuated or coasting wheel/s may comprise a tyre.

In a further example of a collector device, the collector arm/s may be fixedly attached to the enclosure. The enclosure may be much thinner, as retraction means for the collector arms is not necessary. To form a connection to a supply rail, the enclosure and collector arms may be lowered from a raised position to a lowered position in which the collector arms enter the conduits. The collector arms may be of any type described above.

The collector device described herein may be used to retrofit an existing elective vehicle. The device can be easily attached to an existing vehicle, similarly to attaching a trailer to a vehicle. The power cable 104 may then be connected to the vehicle's existing charging port, or may be connected through a junction box to the power circuit/bus of the vehicle. Fuses and relays may be used. This may for example be compatible with existing electric car systems, with or without manufacturer compliance as the original battery (or the electric power generation means in a hybrid vehicle) can be mimicked by the conduits' energy source if necessary. Compatible vehicle types can include full electric, hybrid electric, fuel cell and supplementary generated hydrogen or HHO burning combustion engines. Any vehicle that can utilise electricity in any way will be benefitted.

The collector device can also be fitted and replace overhead wires in tram systems. The systems for detecting the slit, deploying the collector arm, and allowing free movement of the enclosure may be simplified, as rail guided trams will deviate only small amounts from the conduit slit path. However the automated insertion and removal of the collector device, along with safety features, described herein will offer advantages over the conduit systems that have been in public use. A transport system could also be devised that can act as both a tram and a tyred road vehicle.

Vehicles can be built for this system to have much smaller batteries, or none at all. The vehicle may for example rely on capacitor based energy storage and/or combustion engines for road sections not containing the necessary conduits.

It is possible for the collector device to be implemented within a vehicle's footprint, particularly where that vehicle has a large ground clearance. Lorries in particular may be able to easily integrate the collector device in the space between the truck and the trailer. A passenger vehicle may for example be redesigned with a cavity (which could replace the engine bay) underneath for housing a collector device within the vehicle footprint. Implementing with vehicles of lower ground clearance can still be possible without modifications if the enclosure and connector system is made to sufficiently small dimensions. Many vehicles also have sufficient space behind the rear wheels, in the spare wheel bay or fuel tank area, which a retrofitted device can fit under.

The conduit example in FIG. 5a may be taken and optimised for minimal depth and placed on top of the road surface 2503 as shown in FIG. 25 with small conduit 2501. By gently ramping the sides 2502, the movement of, and handling of vehicles crossing the conduit will not be adversely affected. Alternatively, a single lane can be installed with barriers on each side meaning vehicles never drive over the protruding conduit. To allow for compactness of the conduit, insulating shrouds 2504 are placed around the conductor rails 2505, to prevent the conduit (which may be steel) becoming live. As shown by the dotted lines on FIG. 25, a possible internal channel or series of channels 2506 are provided, which allow drainage from the conduit and allow water to flow across the road and under the conduit. Numeral 2507 shows a possible height of ground clearance a vehicle may have in relation to the conduit. A surface mounted conduit may enable existing roads to be upgraded to include an electricity supply system more cheaply and easily than if the conduits are embedded within the road.

FIG. 23 shows a cross section of a conduit with the supply rails omitted. The figure illustrates that additional features may be used to cause water to fall downwards after entering the surface slits, protecting the supply rails from moisture and corrosive or conductive materials in the water. In the illustrated example, linear fins 2301 provide such means of directing droplets downwards, particularly substantially directly downwards.

FIG. 24 shows an example fixed rail 161 that may be fixed on a vehicle and sliding connector 162. FIG. 24 illustrates a method of managing the power cable that connects the vehicle to the collector device. In this example a cable carrier/drag chain 2401 is used to manage the cable as the collector device moves laterally with respect to the vehicle. The power cable leaves the cable carrier at 2403, where it can be fed into the vehicle, and also leaves the cable carrier at 2402 where it can be fed towards the collector device. The chain is anchored at 2404 and attached to sliding connector 163. Cable carriers are commonly used in industry for sliding applications.

It is envisaged that inter-communication of vehicles using the collector device either through a two way wireless communication network or a data connection through the conductor rails can allow external control of the power supplied to each collector device using the conduit. Throttling of power can be used to balance the power demand and reduce power spikes if, for example, a large amount of vehicles engage with the power conduit at once. This is also useful in validating authorised use of the conduit and could also be a safety system, for example by shutting down the conduit when any object not connected to the communication network enters the conduit or contacts the power rails.

Other embodiments are intentionally within the scope of the invention as defined by the appended claims.

1. An electricity collector device for connecting a vehicle to electrical supply rails in a conduit, the device comprising:
a collector system comprising a retractable collector arm adapted to be inserted into a conduit containing an electrical supply rail, and to make electrical contact with the supply rail;
a wheeled enclosure housing the collector system, the wheeled enclosure comprising flanged wheels adapted to be engageable with the conduit;
a vehicle connection for attaching the device to a vehicle, the vehicle connection allowing the enclosure to move with least two degrees of freedom with respect to the vehicle; and
a power cable for connecting the collector system to a vehicle.

2. The collector device of claim 1, wherein the collector arm comprises a collector rod for contacting a supply rail, and an insertion rod attached to the collector arm, wherein the collector rod and/or the insertion rod is adapted to be rotated to contact a supply rail.

3. The collector device of claim 2, wherein the collector rod is rotatably attached to the insertion rod.

4. The collector device of claim 3, wherein the collector arm is adapted to be inserted into a conduit in an insertion direction, and wherein the collector rod is rotatable about a first rotation direction, the rotation direction being substantially parallel to the insertion direction.

5. The collector device of claim 3, wherein the collector arm is adapted to be inserted into a conduit in an insertion direction, and wherein the collector rod is rotatable about a first rotation direction, the rotation direction being substantially orthogonal to the insertion direction.

6. The collector device of claim 5, wherein the collector arm further comprises a support beam, the support beam connecting the collector rod to the insertion rod, wherein the collector rod is rotatably connected to the support beam, and the support beam is rotatably connected to the insertion rod.

7. The collector device of claim 6, wherein the support beam is rotatable with respect to the insertion rod about a second rotation direction, the second rotation direction being substantially orthogonal to the insertion direction, and wherein the collector rod is rotatable with respect to the support beam about the first rotation direction.

8. The collector device of claim 7, wherein the second rotation direction is substantially orthogonal to the first rotation direction.

9. The collector device of claim 4, wherein the collector arm is operable to be translated in a direction opposite to the insertion direction when the insertion rod is rotated away from the insertion direction.

10. The collector device of claim 3, wherein the collector rod is operable to be rotated by an angle of at least 90 degrees from the rotation direction, or by an angle of at least 120 degrees from the rotation direction.

11. The collector device of claim 1, wherein the vehicle connection comprises a slider rail attachable to a vehicle, the slider rail allowing the wheeled enclosure to move laterally with respect to the vehicle.

12. The collector device of claim 1, wherein the vehicle connection allows the enclosure to move with respect to an attached vehicle with five or six degrees of freedom.

13. The collector device of claim 1, wherein the vehicle connection comprises a plurality of rotational joints, each joint providing a degree of freedom to the movement of the enclosure with respect to an attached vehicle.

14. The collector device of claim 1, further comprising a sensor system operable to determine the position of a conduit containing a supply rail, and to direct the collector arm into the conduit.

15. The collector device of claim 14, wherein the sensor system comprises an optical sensor.

16. The collector device of claim 11, further comprising a sensor system operable to determine the position of a conduit containing a supply rail, and to direct the collector arm into the conduit, and wherein at least one sensor of the sensor system is located on the slider rail.

17. The collector device of claim 2, wherein the collector system comprises at least one actuator operable to translate the collector arm and/or rotate the collector rod.

18. The collector device of claim 1, wherein the collector system comprises a second retractable collector arm adapted to be inserted into a second conduit containing a second supply-rail, and to make contact with the second supply rail.

19. The collector device of claim 1, wherein the collector rod comprises rollers configured to interact with a guard covering a conduit.

20. (canceled)

21. A sub-surface electrical supply system for providing electricity to an electricity collector device of a vehicle, the system comprising:
support walls defining an elongate electrical conduit, the support walls comprising a top wall, a bottom wall, and opposing first and second side walls;
an elongate slit in the top wall for receiving a collector arm of an electricity collector device insertable into the conduit, said slit being further adapted to support flanged wheels of a wheeled device; and
an electricity supply rail located in the conduit for supplying electricity to a collector arm of an electricity collector device inserted into the conduit.

22. The supply system of claim 21, wherein the slit is located adjacent to the first side wall, and wherein the supply rail is attached to the second side wall.

23. The supply system of claim 21, further comprising at least one insulating bar between the supply rail and the slit, the insulating bar extending from or attached to the top or bottom wall, the insulating bar adapted to limit access to the supply rail from the slit.

24. The supply system of claim 23, comprising a plurality of insulating fins extending from the bottom wall.

25. The supply system of claim 21, further comprising a drainage port for draining the cavity.

26. The supply system of claim 21, wherein the supply system is adapted to be placed under a road surface such that the top wall is substantially level with the road surface.

27. The supply system of claim 21, further comprising second support walls defining a second elongate conduit, and a second electricity supply rail located in the second conduit.

28. The supply system of claim 23, further comprising a guard covering the elongate slit, wherein the guard is operable to allow a collector arm of an electricity collector device to be inserted through the guard and into the slit.

29. The supply system of claim 28, wherein the guard comprises a first cover and a second cover extending across opposite sides of the slit, the first and second cover meeting to form a seal which is penetrable by a collector arm.

30. A method of supplying electricity to an electric vehicle, the method comprising:
attaching an electricity collector device to the vehicle, the collector device comprising a collector system housed in a wheeled enclosure, the wheeled enclosure able to move with at least two degrees of freedom with respect to the vehicle;
inserting a collector arm of the collector system into a conduit containing an electricity supply rail; and
maneuvering the collector arm inside the conduit until the collector arm contacts the supply rail.

31. The method of claim 30, wherein the collector arm comprises a collector rod for contacting a supply rail, and an insertion rod rotatably connected to the collector arm; and wherein the step of maneuvering the collector arm inside the conduit comprises rotating the collector rod about the insertion rod, so that the collector rod contacts the supply rail.

32. The method of claim 30, wherein the collector arm further comprises a support beam, the support beam connecting the collector rod to the insertion rod, wherein the collector rod is rotatably connector to the support beam, and the support beam is rotatably connected to the insertion rod; and
wherein maneuvering the collector arm inside the conduit comprises:
rotating the support beam about the insertion rod; and
rotating the connector rod about the support beam, so that the collector rod contacts the supply rail.

33. The method claim 30, wherein maneuvering the collector arm inside the conduit comprises:
rotating the collector rod about the insertion rod, so that the collector rod contacts the supply rail; and
partially extracting the collector arm from the conduit with the collector rod rotated, so that the collector rod contacts the supply rail.

34. The method of claim 30, further comprising the step of detecting the conduit with a sensor system of the collector device.

35. The method of claim 30, further comprising the steps of:
detecting that the vehicle has moved a pre-determined distance away from the conduit; and
retracting the collector arm from the conduit.

36. The electricity collector device of claim 1,
wherein the collector system is configured to move laterally relative to the enclosure.

37. The collector device of claim 36, wherein the collector system is further configured to rotate within the enclosure, or to move to adjust the pitch, roll, and/or yaw of the collector device within the enclosure.

38. The collector device of claim 36, wherein the collector device is configured to extend laterally from the enclosure.

39. The collector device of claim 38, wherein the collector device comprises a telescopic extension arm operable to extend the collector device laterally from the enclosure
